(19) United States
(12) Patent Application Publication
(10) Pub. No.: US 2019/0177184 A1
(43) Pub. Date: Jun. 13, 2019

(54) FLUIDIZED BED MEDIA CONTACT CHAMBER

(71) Applicant: A. O. SMITH CORPORATION, Milwaukee, WI (US)

(72) Inventors: David J. AVERBECK, Dousman, WI (US); Ernie Eunkyu LEE, Pewaukee, WI (US); Shi SHUAI, Nanjing, Jiangsu Province (CN); Lin SHI, Nanjing, Jiangsu Province (CN)

(21) Appl. No.: 16/325,558

(22) PCT Filed: Jul. 13, 2017
(86) PCT No.: PCT/US2017/042001

§ 371 Date: Feb. 14, 2019

Related U.S. Application Data
(60) Provisional application No. 62/377,327, filed on Aug. 19, 2016.

(51) Int. Cl. C02F 1/42; B01D 15/36; B01D 61/02; B01D 61/04; B01F 5/04

(52) U.S. Cl. CPC C02F 1/42; B01D 15/361; B01D 61/025; C02F 2101/10; B01F 5/043; C02F 2201/006; C02F 2303/22; B01D 61/04

(57) ABSTRACT

A contact chamber in which a bed of fluid treatment media is fully fluidized by using a fluidizer. The fluidizer may be, for example, an internal or external eductor that acts as a pump for a media and fluid mixture to boost fluid flow and generate recirculation that keeps the media suspended in the fluid or an arrangement of nozzles, mixing blades, pumps, baffles, or irregular cross-sectional shapes (or combinations of any of these) to promote fully fluidizing the media in the chamber and causing the media to recirculate within the chamber.

### RELATED APPLICATIONS

The application claims priority to U.S. Provisional Application No. 62/377,327, filed on Aug. 19, 2016, which is incorporated herein by reference.

### BACKGROUND

The present disclosure relates to a fluidized bed media contact chamber. Such contact chambers, which are sometimes referred to as reaction chambers or reactors, are used to pretreat fluid prior to the fluid's end use, which may include consumption (e.g., as drinking water) or introduction of the fluid into a downstream system. Examples of downstream systems include, without limitation: the plumbing of a building; a reverse osmosis (RO) system; a water heater; a boiler; and a humidifier. The treated fluid may reduce adverse effects (e.g., scale buildup or corrosion) on such downstream systems. In some applications, the contact chamber may be integrated with the downstream system.

Within the contact chamber is a fluid treatment media which treats the fluid in desired ways, but usually by ion exchange or catalytic treatment. Consequently, the fluid treatment media discussed in this specification can be characterized as media that engages in ion exchange or catalytic treatment with the fluid it contacts. For example, some types of fluid treatment media (referred to as scale control media) are used to reduce the formation of scale in a downstream system. The fluid treatment media may be provided in a variety of natural and synthetic materials, which are often provided in the shape of beads. One example of a fluid treatment media is a resin useful for reducing scale.

### SUMMARY

The disclosure provides a contact chamber in which a bed of fluid treatment media is fully fluidized by using a fluidizer. The fluidizer may be, for example, an internal or external eductor that acts as a pump for a media and fluid mixture to boost fluid flow and generate recirculation that keeps the media suspended in the fluid or an arrangement of nozzles, mixing blades, pumps, baffles, or irregular cross-sectional shapes (or combinations of any of these) to promote fully fluidizing the media in the chamber and causing the media to recirculate within the chamber.

Other aspects of the disclosure will become apparent by consideration of the detailed description and accompanying drawings.

### BRIEF DESCRIPTION OF THE DRAWINGS

FIG. 1 illustrates a conventional contact chamber set up for relatively low fluid flow rates, the contact chamber being in a low flow condition.

FIG. 2 illustrates a conventional contact chamber set up for relatively high fluid flow rates and in an at-rest condition.

FIG. 3 illustrates the contact chamber of FIG. 2 in a high flow condition.

FIG. 4 illustrates a conventional contact chamber in a fully fluidized condition.

FIG. 5 illustrates a contact chamber modified with a fluidizer to promote full fluidization of the media according to some constructions.

FIG. 6 illustrates a section view of the contact chamber of FIG. 5 taken along the line 6-6.

FIG. 7 illustrates an enlarged view of a portion of FIG. 6.

FIG. 8 illustrates a contact chamber modified with a fluidizer to promote full fluidization of the media according to another construction.

FIG. 9 illustrates a section view of the contact chamber of FIG. 8 taken along the line 9-9.

FIG. 10 illustrates an enlarged view of the fluidizer of FIG. 9.

FIG. 11 illustrates a contact chamber modified with a fluidizer to promote full fluidization of the media according to another construction.

FIG. 12 illustrates a section view of the contact chamber of FIG. 11 taken along the line 12-12.

FIG. 13 illustrates an enlarged view of the fluidizer of FIG. 12.

FIG. 14 illustrates a contact chamber modified with a fluidizer to promote full fluidization of the media according to another construction.

FIG. 15 illustrates an exploded view of the contact chamber of FIG. 14.

FIG. 16 illustrates a detail view of a fluidizer for use with the contact chamber of FIG. 14.

FIG. 17 illustrates an enhanced recirculating contact chamber having an external eductor.

FIG. 18 illustrates a contact chamber according to the present disclosure including a plurality of external mixing nozzles.

FIG. 19 illustrates a contact chamber according to the present disclosure including a plurality of internal mixing nozzles.

FIG. 20 illustrates a contact chamber according to the present disclosure including mechanical mixing and recirculation.

FIG. 21 illustrates a contact chamber according to the present disclosure including an internal pump.

FIG. 22 illustrates a contact chamber according to the present disclosure including an external pump.

FIG. 23 illustrates a contact chamber according to the present disclosure including a plurality of baffles.

FIG. 24 illustrates a contact chamber according to the present disclosure having an irregular shape.

FIG. 25 is a graph of the efficacy, in terms of maintaining the production water flow rate, of a reverse osmosis (RO) system receiving water from a conventional contact chamber compared to that of an RO system receiving water from a contact chamber according to the present disclosure.

FIG. 26 is a graph of the efficacy, in terms of maintaining the ion rejection percentage, of a reverse osmosis (RO) system receiving water from a conventional contact chamber compared to that of an RO system receiving water from a contact chamber according to the present disclosure.

FIG. 27 is a graph demonstrating the efficacy of the present disclosure for scale prevention in water heaters.

### DETAILED DESCRIPTION

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways.

### Conventional Contact Chambers

The term “conventional contact chamber” is used to describe a contact chamber through which a fluid (e.g., water) flows in a single pass without substantial change in velocity or intentional recirculation of the fluid within the contact chamber. Such conventional contact chambers are usually defined within a cartridge that includes a fluid inlet and a fluid outlet that communicate with the contact chamber. Fluid flows through the fluid inlet into the contact chamber at an inlet flow rate and flows out of the contact chamber through the fluid outlet at an outlet flow rate. The inlet flow rate and outlet flow rate are usually equal because the fluid entering the contact chamber through the fluid inlet displaces an equal volume of fluid out of the contact chamber through the fluid outlet. Within the conventional contact chamber is a bed of fluid treatment media (referred to simply as the “media”). The media engages in ion exchange with or catalytic treatment of the fluid flowing through the contact chamber.

The media is most effective (i.e., catalytic effect or ion exchange is improved) when the media is fluidized. The term “fluidized” and its variations means that the media is suspended in the fluid within the contact chamber. The media can be said to be “fully fluidized” when all media in the bed is suspended in the fluid. Fully fluidized media maximizes the contact and interaction (such as mass transfer) between the fluid and the media for most efficient use of the media in a conventional contact chamber. Conventional contact chambers are designed for a fixed or narrow range of fluidic conditions (e.g., fluid temperature, media size, media weight or density, bed height, bed void volume, total mass of solids in the bed, and fluid flow rate). Only if the fluidic conditions are met will the media be fully fluidized.

A common fluid treated with a conventional contact chamber is water. One aspect of the fluidic conditions—flow rate—can be widely variable for water in many environments. In a residential application the water flow rate can vary 0-10 gpm. Thus a conventional contact chamber may be ineffective over much of the range of water flow rates it will experience in operation.

For example, media with a bead size of 0.3-1.1 mm and density of 7.7 g/liter can be fully fluidized in a 23.5 cm height conventional contact chamber with 5 cm media bed depth when operated with the water at a temperature of 20° C. flowing vertically upwards at a velocity of 132 cm/min. If the water velocity is less than about 42 cm/min with 5 cm media depth, the bed does not fully fluidize; the vertical lift caused by the fluid friction is not enough to overcome gravity and much of the media remains packed in the bottom of the contact chamber. This can be referred to as the low flow case. Under 25 cm/min flow speed, the media does not expand at all. If the velocity is greater than 160 cm/min under these conditions the media bed is only partially fluidized; the vertical lift caused by the fluid friction is too high and overcomes gravity, resulting in much of the media being trapped at the top of the contact chamber and forming a packed bed. This can be referred to as the high flow case.

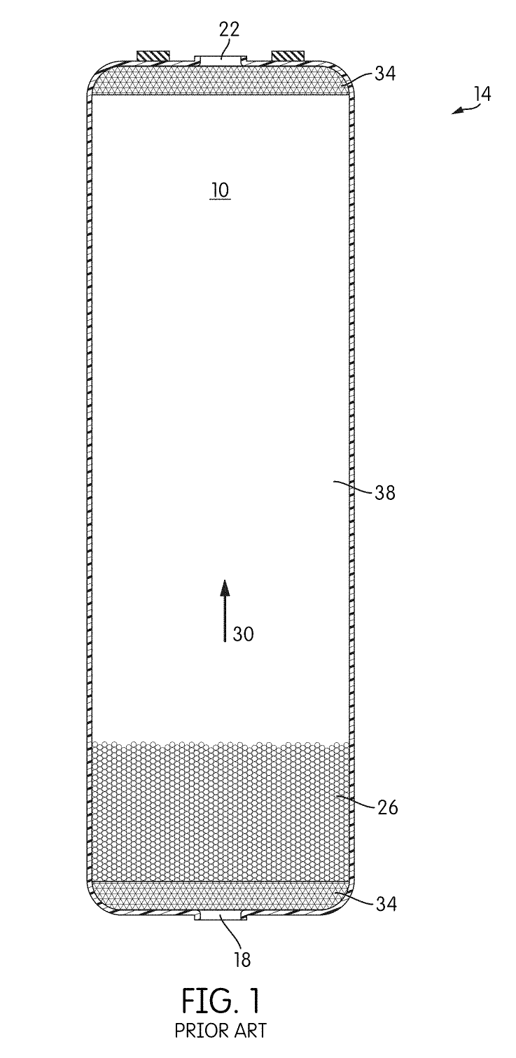

FIG. 1 illustrates a conventional contact chamber 10 set up for relatively low fluid flow rates. The contact chamber 10 is defined within a cartridge 14 having a feed fluid inlet 18 at one end and a treated fluid outlet 22 at an opposite end. The feed fluid inlet 18 and treated fluid outlet 22 both communicate with the contact chamber 10. The contact chamber 10 is illustrated as being vertically-extending with the feed fluid inlet 18 at the bottom and the treated fluid outlet 22 at the top. The contact chamber 10 is always illustrated in this orientation throughout this specification for consistency. In some constructions and applications, however, the contact chamber 10 may be positioned in other attitudes or orientations; the disclosure is not limited to the vertical orientation illustrated.

A bed of media 26 is deposited at the bottom of the contact chamber 10. The media bed is relatively short, shallow, or small because a relatively low fluid flow rate is expected. Such low fluid flow rate gives rise to only sufficient friction and lift to fully fluidize a relatively small amount of media 26. Also, the slower-moving fluid will have more time to interact with each media particle or bead, so a relatively small amount of media 26 can adequately treat the fluid moving at a relatively lower rate.

The fluid flows in an upward direction 30 from the feed fluid inlet 18, through the media 26, to the treated fluid outlet 22. The media 26 is more dense than the fluid and therefore settles to the bottom of the contact chamber 10 in the absence of sufficient upward fluid flow. In other constructions, the media 26 may be of lower density such that the media beads are buoyant in the fluid. In such instances, the fluid flow may be directed downwardly into the contact chamber 10 (i.e., the contact chamber 10 and plumbing are flipped upside down from what is illustrated in the examples of this specification), or the contact chamber 10 may be mounted horizontally, relying on the higher velocity provided by recirculation to fluidize the media 26.

Plastic mesh 34 may be provided at each end of the contact chamber 10. The mesh 34 size is smaller than the media 26 to prevent the media 26 from escaping the contact chamber 10 through the feed fluid inlet 18 and treated fluid outlet 22. Alternatively, screens, strainers, open cell foam or fiber pads may be used to prevent the media from escaping the contact chamber through the feed fluid inlet 18 or treated fluid outlet 22. Inlet check valves, or inlet isolation valves may also be used to prevent the media 26 from leaving the contact chamber 10 through the feed fluid inlet 18. A gasket, O-ring, thread, or compression fitting may be provided at either or both ends to ensure a fluid-tight seal with the fluid supply to the feed fluid inlet 18 or the downstream system.

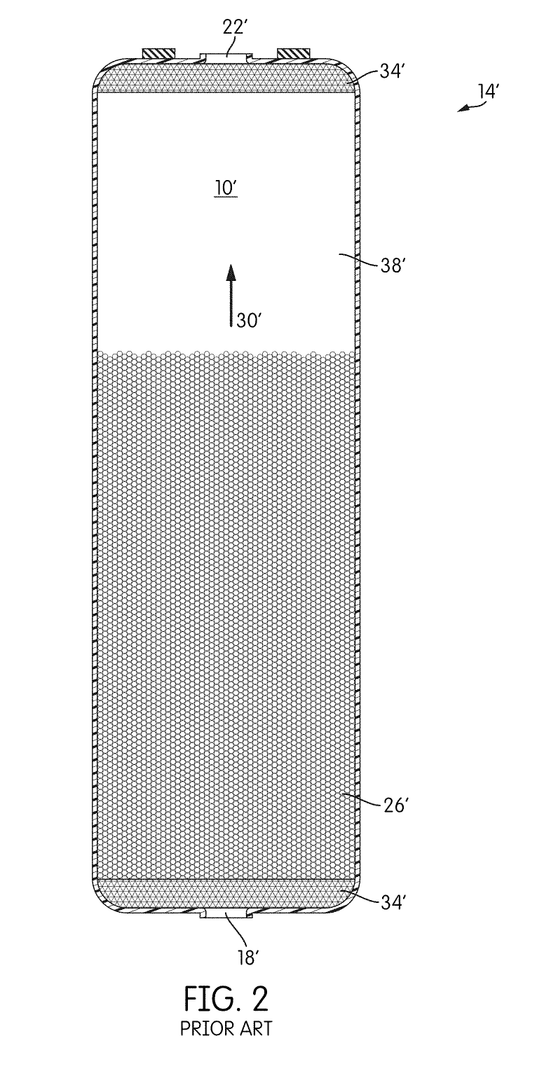

FIG. 2 illustrates a conventional contact chamber 10′ set up for relatively high fluid flow rates. The contact chamber 10′ is the same as in FIG. 1, but the media bed is much higher than the media bed illustrated in FIG. 1 because of the expected high fluid flow rate. Like parts in the construction of FIG. 2 will be indicated using the prime symbol (“′”). With higher flow rates, there is less contact time between the media 26′ and the fluid and more media 26′ is required to achieve the desired treatment. In this regard, conventional contact chambers are tuned for the expected flow rate by adjusting the size or height of the media bed to reflect the contact time the fluid is expected to have with the media. More media is used since the expected contact time decreases (i.e., as the expected fluid flow rate increases).

As noted, the contact chambers 10 and 10′ illustrated in FIGS. 1 and 2 are set up for an expected low or high fluid flow rate, respectively. The performance of the contact chamber 10, 10′ is optimized (i.e., the media 26, 26′ is fully fluidized) when the fluid flow is within a given range around the expected flow rate. When fluid flow rates are outside of the given range, dead zones 38, 38′ (i.e., bands of media-free fluid) are formed in which the media 26, 26′ is not fluidized. The fluid is not being treated in the dead zones 38, 38′ and the contact time of fluid and media 26, 26′ is shortened to a non-optimal level.

In a low flow condition (i.e., when the fluid flow rate is lower than the optimum range), the media 26, 26′ may not be fluidized throughout the entire contact chamber 10, 10′. The media 26, 26′ may only be lifted part way up the height of the contact chamber 10, 10′. In such conditions, the area above the fluidized media is a dead zone 38, 38′.

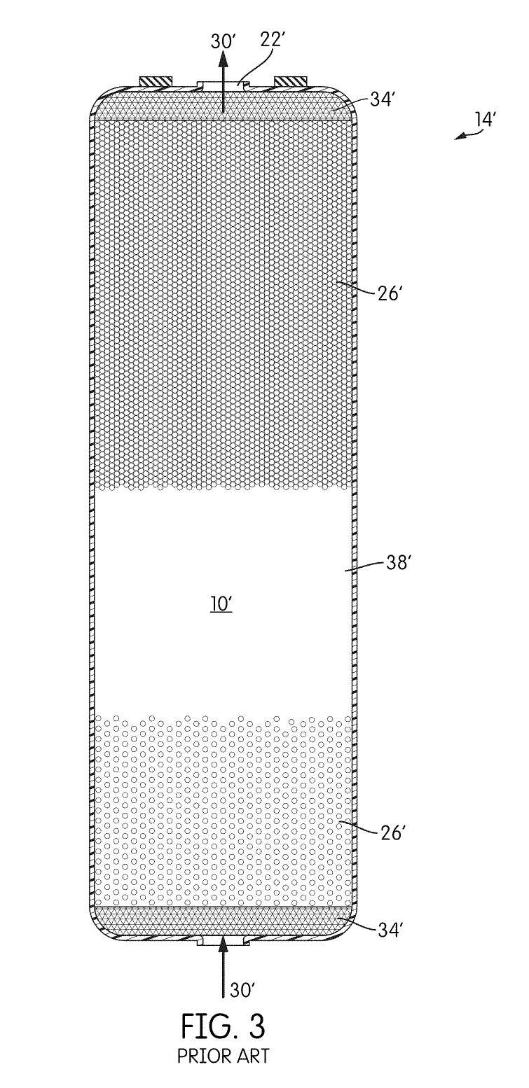

FIG. 3 illustrates the conventional contact chamber setup of FIG. 2 in the high flow condition (i.e., when fluid flow exceeds the optimum range). As illustrated, a portion of the media 26′ is compacted against the top of the contact chamber 10′ by the higher-than-optimum flow rates. A remaining portion of the media bed is fluidized at the bottom portion of the contact chamber 10′. A dead zone 38′ forms between the fluidized media 26′ at the bottom and the non-fluidized media 26′ at the top.

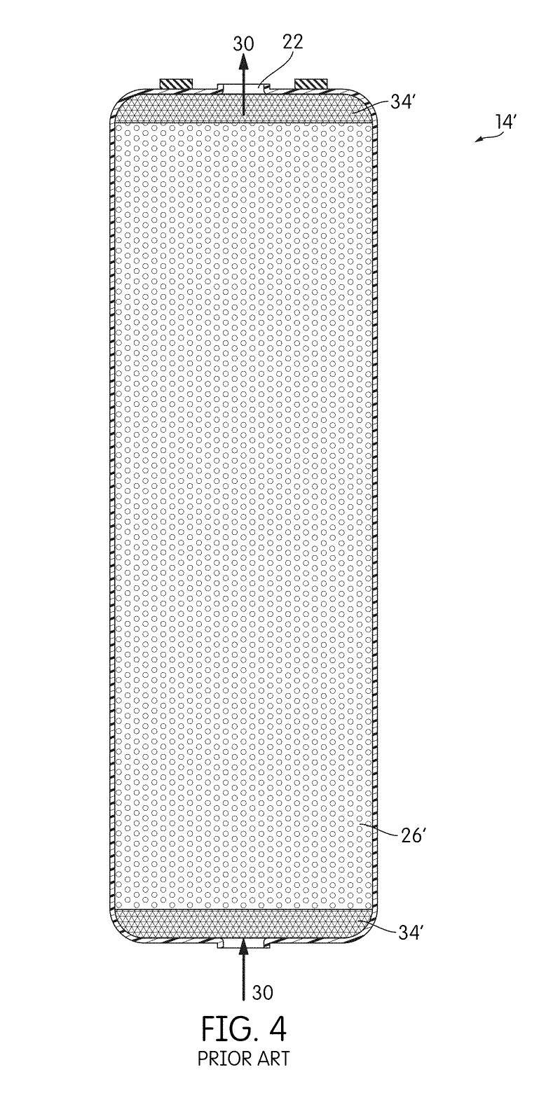

FIG. 4 illustrates a conventional contact chamber 10, 10′ in a fully fluidized condition. Here it can be seen that the media bed is dispersed throughout the entire volume of the contact chamber 10, 10′. This achieves maximum interaction between the media 26, 26′ and the fluid.

An example of fluid treated by the illustrated conventional contact chambers of FIGS. 1-4 is water, and an example of media is scale control media. The scale control media may be, for example, a resin. There are many other types of media used for treating water and other fluids, and the present disclosure is not limited to scale reduction applications.

### Improved Contact Chamber

One aspect of the present disclosure is to provide a fluidizer which achieves full fluidization of a bed of media over a wider range of flow rates compared to a conventional contact chamber. Another aspect of the present disclosure is to provide a fluidizer which achieves full fluidization of a wider range of media bed depths for a given flow rate compared to a conventional contact chamber. Yet another aspect of the present disclosure is to provide a recirculation enhancing contact chamber (RECC) which promotes recirculation of fluid in the contact chamber. The term “recirculation” is used to refer to the media in the contact chamber moving in a direction opposite the main flow of fluid in the contact chamber and thereby resulting in more time for the media particles to interact with the fluid and rub against other media particles.

In the case where the media is used for scale control purposes, the shearing forces arise from the media particles rubbing against each other, and the shearing forces cause crystals to break off of the media particles and become suspended in the fluid. Shearing crystals off of the media particles regenerates the media in the sense that nucleation sites are re-opened on the media. Additionally, the suspended crystals continue to offer nucleation sites. In summary, recirculation can give rise to much more interaction of the media with the fluid than the single-pass flow profile of a conventional contact chamber.

In the example of water as the fluid and scale control media as the media, the scale control media absorbs calcium and carbonate ions from the water, forming crystals of calcium carbonate on the surface of the media. Additionally, scale that is formed after treatment through the system is typically of a different crystal structure—aragonite form instead of calcite form—which is less adherent onto surfaces in downstream systems.

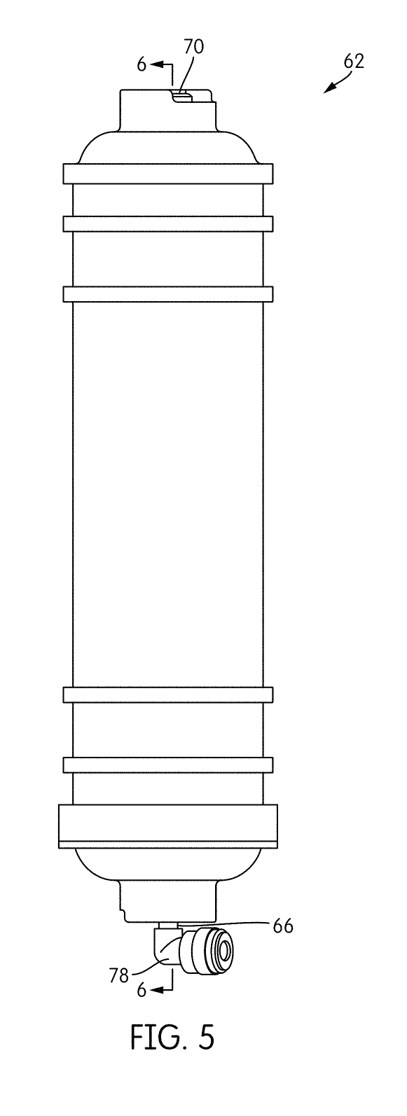

FIGS. 5-7 illustrate a cartridge 62 including a feed fluid inlet 66 and a treated fluid outlet 70 and defines a contact chamber 74. The feed fluid inlet 66 may be adapted to engage a fluid inlet conduit 78 for receiving inlet fluid from a source. The treated fluid outlet 70 is adapted to engage a fluid outlet conduit for transferring treated fluid to a downstream application. The contact chamber 74 includes a fluidizer 82, a lower mesh layer 86, a deflector cap 94, and media. The lower mesh layer 86 is positioned near the feed fluid inlet 66 to prevent media from entering the feed fluid inlet 66. In some constructions, an upper mesh layer (not shown) may be positioned near the treated fluid outlet 70 to prevent media from entering the treated fluid outlet 70. In other constructions, the deflector cap 94 includes openings 90 sized to allow treated fluid to flow to the outlet 70 while preventing the media from entering the treated fluid outlet 70. The deflector cap 94 may be positioned at the top of the contact chamber 74 to deflect fluid downwardly to promote recirculation.

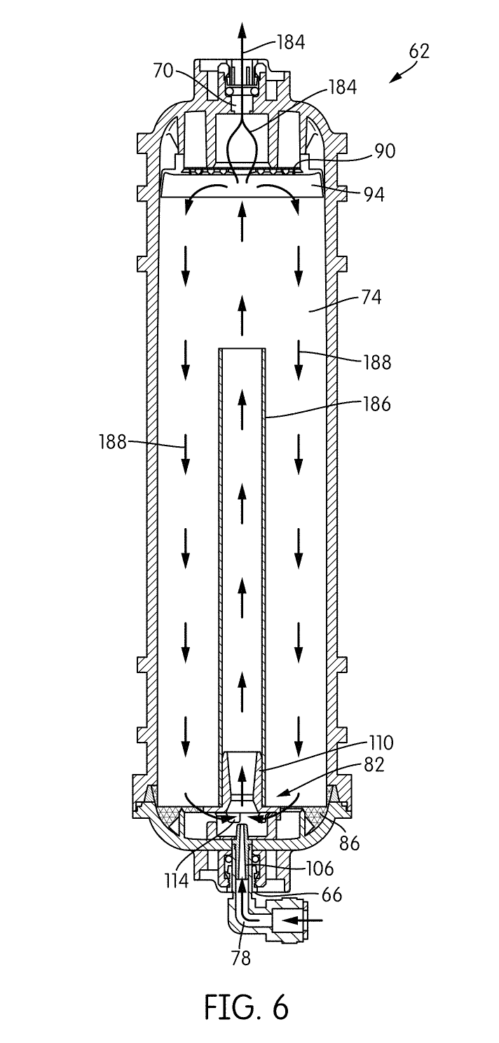

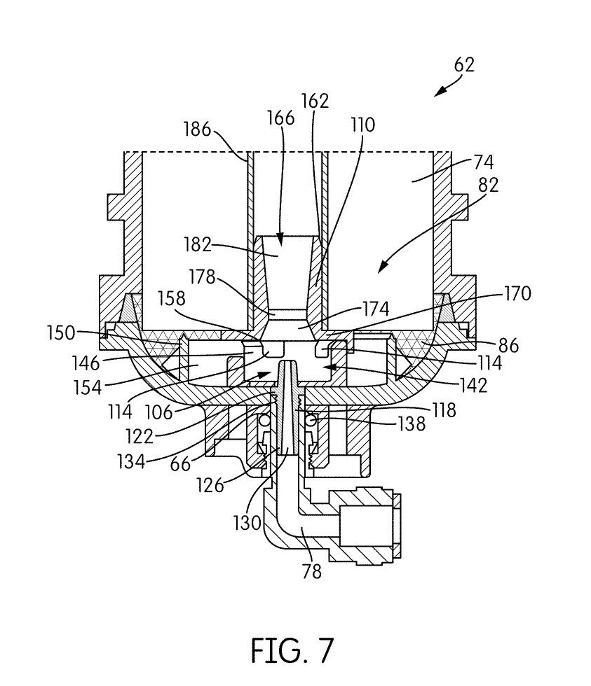

As shown in FIGS. 6-7, the fluidizer 82 is an eductor including a nozzle 106, a venturi tube 110, and one or more suction openings 114 positioned between the nozzle 106 and the venturi tube 110. As is best shown in FIG. 7, in the illustrated construction, the nozzle 106 includes an upper portion 118, a seat 122, a lower portion 126, and a tapered interior cavity 130. The nozzle 106 is positioned between the feed fluid inlet 66 and the fluid inlet conduit 78 so that the tapered interior cavity 130 is in fluid communication between the fluid inlet conduit 78 and the cartridge 62. As shown in FIG. 7, the lower portion 126 of the nozzle 106 is positioned within the fluid inlet conduit 78. The tapered cavity 130 is dimensioned so that the nozzle 106 increases a flow rate of fluid flowing into the contact chamber 74. For example, in the illustrated construction, a cross-sectional area of the tapered cavity 130 is widest proximate the feed fluid inlet 66 and decreases so that the cross-sectional area is smallest proximate the contact chamber 74. In the illustrated construction, the seat 122 is positioned between the fluid inlet conduit 78 and the feed fluid inlet 66. In the illustrated construction, the lower portion 126 of the nozzle 106 includes external threads 134 proximate the seat 122. The external threads 134 engage internal threads of the fluid inlet conduit 78. In other constructions, the nozzle 106 may be engaged with the fluid inlet conduit 78 using other methods, such as a compression fitting, an adhesive, or sealing devices such as o-rings. In the illustrated construction, o-rings 138 are used to form a fluid-tight seal between the nozzle 106 and the feed fluid inlet 66. In other constructions, the nozzle 106 may be secured to cartridge 62 using a threaded connection, a friction fit, or an adhesive.

As shown in FIG. 7, a suction zone 142 of the fluidizer 82 is generated or established between the nozzle 106 and the venturi tube 110. In the illustrated construction, the suction zone 142 is established or generated between an inner protrusion 146, the venturi tube 110, and the bottom of the cartridge 62. The inner protrusion 146 extends upwardly (e.g. into the contact chamber 74) from the bottom of the cartridge 62 and is adapted to engage the venturi tube 110 as is described in more detail below. A plurality of suction openings 114 is formed around the circumference of an upper portion of the inner protrusion 146. In some constructions, an outer protrusion 150 may surround the inner protrusion 146. In such constructions, a plurality of ribs 154 extends between the inner protrusion 146 and the outer protrusion 150. In such a construction, the suction openings 114 are formed between pairs of ribs 154. The inner protrusion 146 and the outer protrusion 150 may be substantially circular and concentric with respect to each other and with respect to the nozzle 106.

With continued reference to FIG. 7, the venturi tube 110 includes a venturi tube inlet 158, a venturi tube outlet 162, a cavity 166, and a cartridge engagement portion 170. The cavity 166 includes a first tapered portion 174, a choke portion 178, and a second tapered portion 182. In the illustrated construction, the first tapered portion 174 extends between the venturi tube inlet 158 and the choke portion 178. The first tapered portion 174 is dimensioned so that a cross-sectional area of the first tapered portion 174 is the widest proximate the venturi tube inlet 158 and the cross-sectional area of the first tapered portion 174 is the narrowest adjacent the choke portion 178. The second portion 182 is dimensioned so that a cross-sectional area of the second tapered portion 182 is narrowest adjacent the choke portion 178 and the cross-sectional area of the second tapered portion 182 is widest proximate the venturi tube outlet 162. The choke portion 178 is substantially cylindrical and has a cross-sectional area that is substantially the same as the narrowest cross-sectional area of the first tapered portion 174 and the narrowest cross-sectional area of the second tapered portion 182. In the illustrated construction, the cartridge engagement portion 170 is adapted to engage the inner protrusion 146 formed in the bottom of the cartridge 62. In the illustrated construction, the cartridge engagement portion 170 is compression fitting against the inner protrusion 146. In other constructions, the cartridge engagement portion 170 may be secured to the inner protrusion 146 by other methods, such as a threaded connection, an adhesive, or sealing members such as o-rings.

In the construction of FIGS. 5-7, a venturi tube extension 186 (FIGS. 6 and 7) may engaged with the venturi tube 110. In some constructions, a length of the venturi tube 110 can be effectively increased and decreased by adding and removing venturi tube extensions 186. The venturi tube extensions 186 may be used, for example, when the media bed is particularly deep so that the venturi tube 110 extends higher than the media bed. Stated more broadly, the media bed is at a first end of the contact chamber 74 and the venturi tube extension 186 extends through the media bed and is operable to move media from the media bed to a second end of the contact chamber 74 opposite the first end. The venturi tube extension 186 may be length-adjustable (telescoping or comprised of stackable extension segments, for example) or replaceable with a venturi tube extension 186 of different length for a given contact chamber 74 and media bed depth.

In operation, the nozzle 106 causes the velocity of fluid entering the contact chamber 74 to increase as it enters the venturi tube 110. At the same time, the nozzle 106 causes the pressure to drop in the suction zone 142 (i.e., a vacuum at the suction openings 114). The vacuum draws a fluid and media mixture through the suction opening(s) 114 into the suction zone 142 where it is entrained in the flow from the nozzle 106 to the venturi tube 110. The pressure of the fluid increases as the fluid approaches the top of the venturi tube 110.

The fluidizer 82 therefore entrains media into the fluid flow and boosts the pressure of the fluid so that the fluid flows higher in the contact chamber 74 than it would under the conventional contact chamber configuration 10, 10′. A shown in FIG. 6, the fluidized media is discharged out of the venturi tube 110. A volume of the treated fluid (arrows 184) flows around the deflector cap 94 and through the treated fluid outlet 70. A volume of fluid and media (arrows 188) equal to the volume of fluid and media drawn in through the suction opening(s) 114 is recirculated back to the bottom of the contact chamber and into the suction opening(s) 114 again. Thus, the eductor increases the volumetric flow of fluid and media in the contact chamber 74 compared to a conventional single-pass contact chamber 10, 10′.

The fluidizer 82 is sized to create a fully-fluidized media bed in both the low flow condition and the high flow condition to avoid dead zones 38, 38′ in the contact chamber 74. The eductor creates a fully-fluidized media bed in the low flow condition because the venturi effect increases the fluid velocity within the contact chamber 74 to as much as (more or less) four times the velocity of fluid entering the contact chamber 74 through the feed fluid inlet 66. This higher velocity flow prevents media from settling at the bottom of the contact chamber 74 in the low flow condition.

The fluidizer 82 creates a fully-fluidized media bed in the high flow condition by deflecting much of the fluid and media off of the deflector cap 94. The deflected fluid and media (arrows 188) create downward recirculation that flows down along the outside of the venturi tube extension 186 and the venturi tube 110 and is drawn into the suction openings 114 again. The fluid and media mixture recirculate within the contact chamber 74 at a rate of (more or less) three times the inlet/outlet fluid velocity. The downward velocity of recirculating fluid and media (arrows 188) prevents a packed bed from forming at the top of the contact chamber 74. Fluid flows out of the openings 90 in the cap 94 to the treated fluid outlet while keeping the media in the contact chamber 74. If an upper mesh layer is used instead of the openings 90, the mesh layer may be positioned around the deflector cap 94 to prevent media from circumventing the deflector cap 94. The flow rate out of the contact chamber 74 through the treated fluid outlet 70 equals the flow rate into the contact chamber 74 via the feed fluid inlet 66. The deflector cap 94 bears most of the impact of the media.

The fluidizer 82 illustrated in FIGS. 6-7 is merely one example of a fluidizer according to the present disclosure. Other examples of fluidizers are included in the following figures and description.

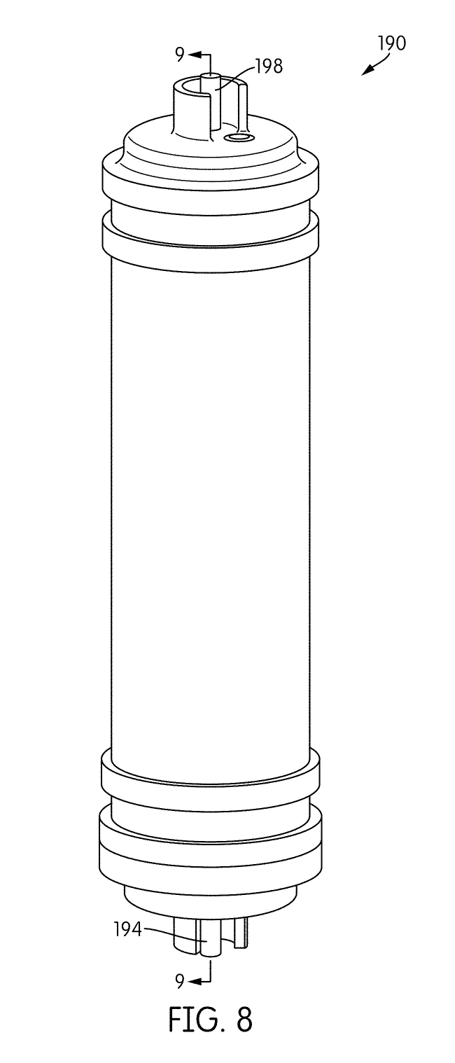

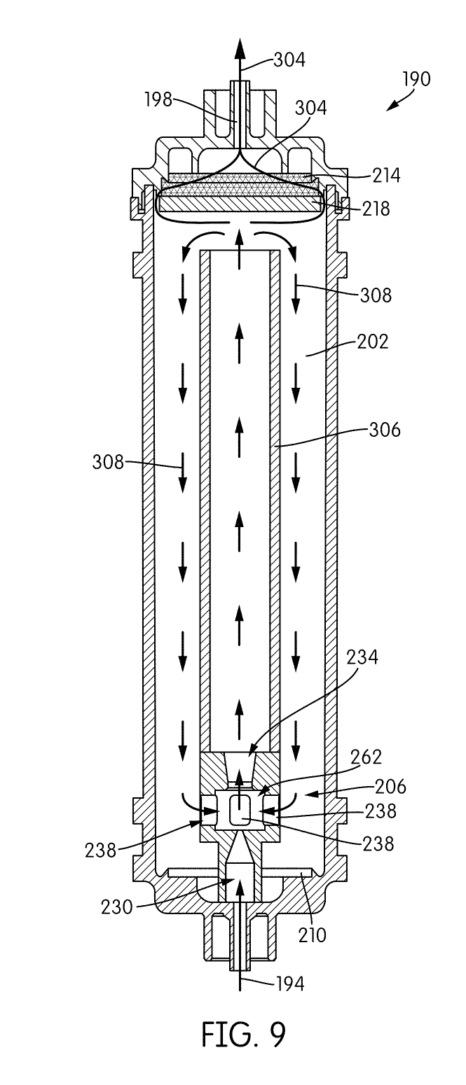

FIGS. 8-10 illustrate a cartridge 190 according to another construction, in which the cartridge 190 includes a feed fluid inlet 194, a treated fluid outlet 198, and defines a contact chamber 202 (FIG. 9). The feed fluid inlet 194 may be adapted to engage a fluid inlet conduit (not shown) for receiving inlet fluid from a source. The fluid outlet 198 may be adapted to engage a fluid outlet conduit (not shown) for transferring treated fluid to a downstream application. The contact chamber 202 includes a fluidizer 206, a lower mesh layer 210, an upper mesh layer 214, a deflector cap 218, and media. The lower mesh layer 210 is positioned near the feed fluid inlet 194 to prevent media from entering the feed fluid inlet 194. The upper mesh layer 214 is positioned near the treated fluid outlet 198 to prevent media from entering the treated fluid outlet 198. The deflector cap 218 may be positioned on the mesh at the top of the contact chamber 202 to deflect fluid downwardly to promote recirculation.

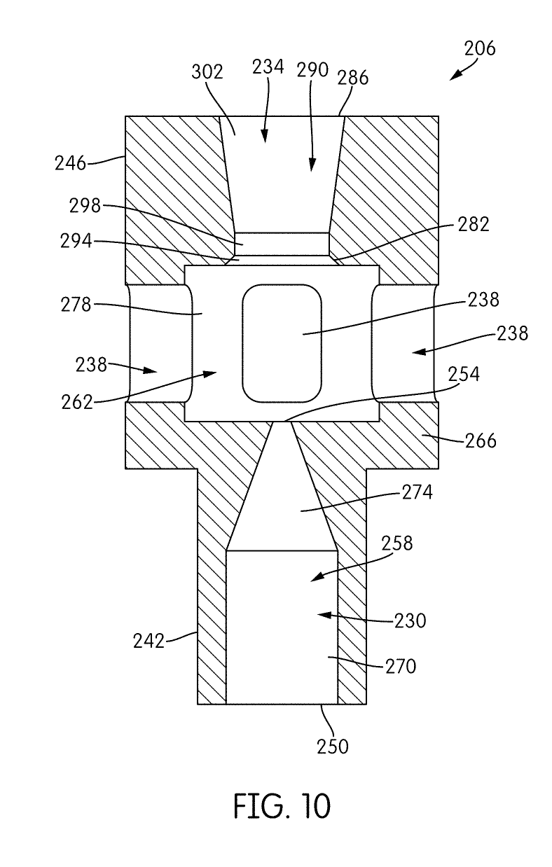

As shown in FIG. 10, the fluidizer 206 is an integrated eductor formed in a monolithic block having a first portion 242 defining a nozzle 230, a second portion 246 defining a venturi tube 234, and a suction zone 262 defined between the first and second portions 242, 246. The suction zone 262 includes a plurality of suction openings 238 through a circumferential wall 278 of the fluidizer 206.

In the illustrated construction, a diameter of the first portion 242 is smaller than a diameter of the second portion 246. The nozzle 106 includes a nozzle inlet 250, a nozzle outlet 254, and a nozzle cavity 258 formed between the nozzle inlet 250 and the nozzle outlet 254. The nozzle inlet 250 is engagable with the feed fluid inlet 194 of the cartridge 190 and positioned adjacent a bottom of the cartridge 190 (FIG. 9). The nozzle outlet 254 communicates with the suction zone 262 through a wall 266 of the first portion 242. In the illustrated construction, the nozzle cavity 258 includes a cylindrical portion 270 proximate the nozzle inlet 250 and a tapered portion 274 proximate the nozzle outlet 254. The tapered portion 274 is shaped so that a cross-sectional area of the tapered portion 274 decreases towards the nozzle outlet 254. Accordingly, a cross-sectional area of the nozzle inlet 250 is larger than a cross-sectional area of the nozzle outlet 254.

Referring again to FIG. 10, the venturi tube 234 includes a venturi tube inlet 282, a venturi tube outlet 286, and a cavity 290. The venturi tube inlet 282 is adjacent and in fluid communication with the suction zone 262. The cavity 290 includes a first tapered portion 294, a choke portion 298, and a second tapered portion 302. In the illustrated construction, the first tapered portion 294 extends between the venturi tube inlet 282 and the choke portion 298. The first tapered portion 294 is dimensioned so that a cross-sectional area of the first tapered portion 294 is the widest proximate the venturi tube inlet 282 and the cross-sectional area of the first tapered portion 294 is the narrowest adjacent the choke portion 298. The second tapered portion 302 is dimensioned so that a cross-sectional area of the second tapered portion 302 is narrowest adjacent the choke portion 298 and the cross-sectional area of the second tapered portion 302 is widest proximate the venturi tube outlet 286. The choke portion 298 is substantially cylindrical and has a cross-sectional area that is substantially the same as the narrowest cross-sectional area of the first tapered portion 294 and the narrowest cross-sectional area of the second tapered portion 302.

In the construction of FIGS. 8-10, a venturi tube extension 306 (FIG. 9) is engaged with the venturi tube 234. The venturi tube extension 306 is substantially similar to the venturi tube extension 186 and will not be described in detail for the sake of brevity.

The fluidizer 206 therefore entrains media into the fluid flow and boosts the pressure of the fluid so that the fluid flows higher in the contact chamber 202 than it would under the conventional contact chamber configuration 10, 10′. A shown in FIG. 9, the fluidized media is discharged out of the venturi tube 110. A volume of the treated fluid (arrows 304) flows around the deflector cap 218 and through the treated fluid outlet 198. A volume of fluid and media (arrows 308) equal to the volume of fluid and media drawn in through the suction opening(s) 238 is recirculated back to the bottom of the contact chamber and into the suction opening(s) 238 again. Thus, the fluidizer 206 increases the volumetric flow of fluid and media in the contact chamber 202 compared to a conventional single-pass contact chamber 10, 10′.

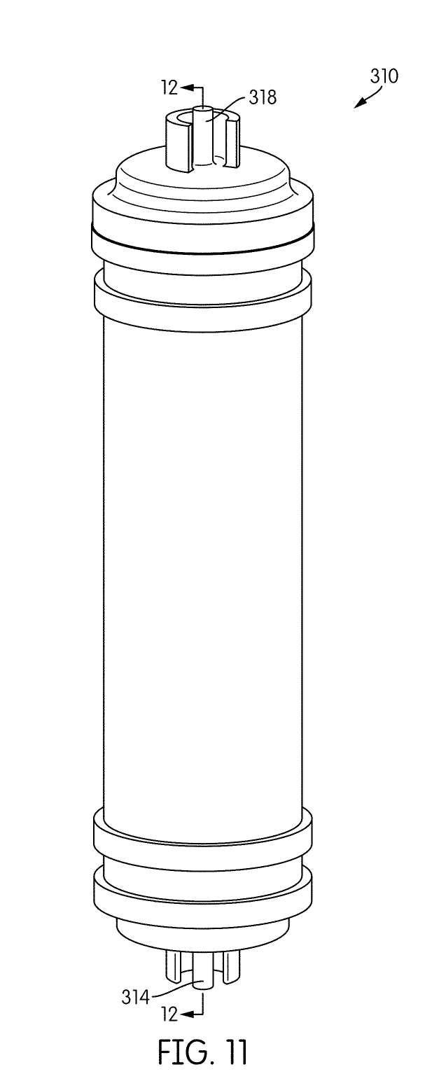

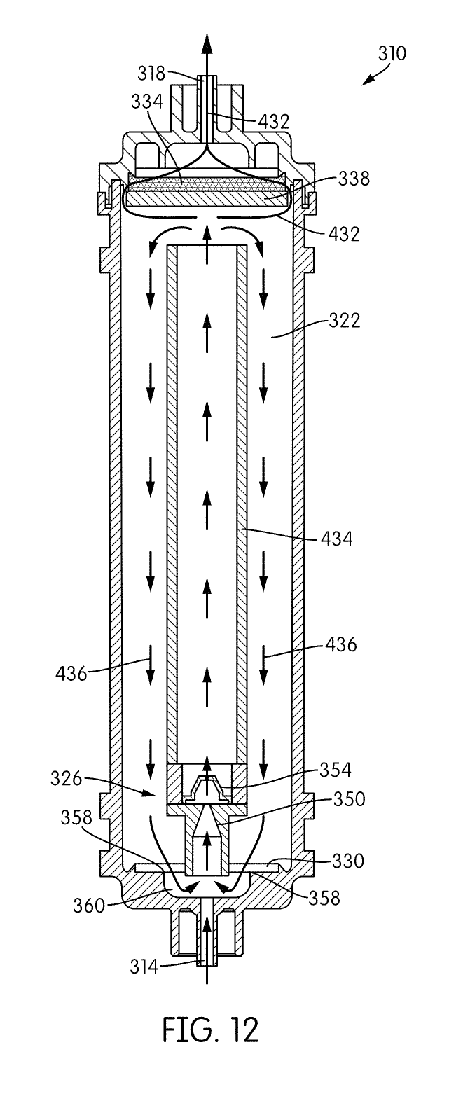

FIGS. 11-13 illustrate a cartridge 310 according to another construction. The cartridge 310 includes a feed fluid inlet 314, a treated fluid outlet 318, and defines a contact chamber 322 (FIG. 12). The feed fluid inlet 314 may adapted to engage a fluid inlet conduit (not shown) for receiving inlet fluid from a source. The treated fluid outlet 318 may be adapted to engage a fluid outlet conduit (not shown) for transferring treated fluid to a downstream application. The contact chamber 322 includes a fluidizer 326, a lower mesh layer 330, an upper mesh layer 334, a deflector cap 338, and media. The lower mesh layer 330 is positioned near the feed fluid inlet 314 to prevent media from entering the feed fluid inlet 314. The upper mesh layer 334 is positioned near the treated fluid outlet 318 to prevent media from entering the treated fluid outlet 318. The deflector cap 338 may be positioned on the mesh at the top of the contact chamber 322 to deflect fluid downwardly to promote recirculation.

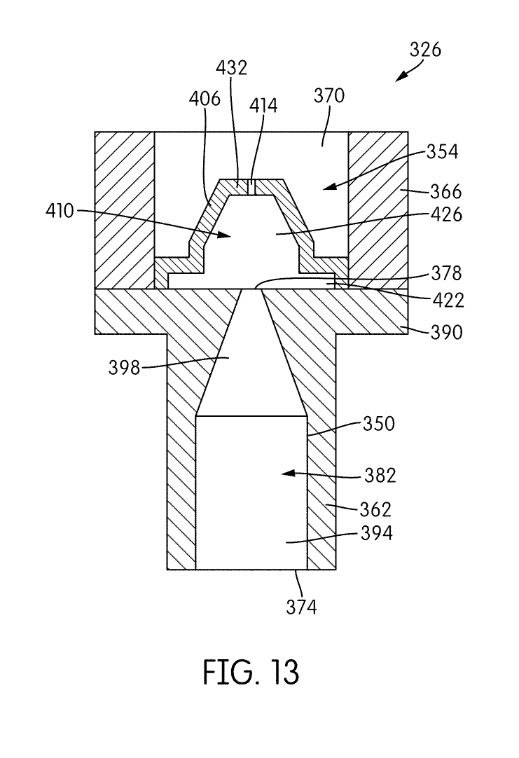

As shown in FIGS. 12-13, the fluidizer 326 is an eductor including a nozzle 350, a venturi tube 354, and one or more suction openings 358 positioned between the nozzle 350 and a cavity 360 formed in a bottom of the cartridge 310. With particular reference to FIG. 13, the fluidizer 326 includes a first portion 362 including the nozzle 350 and a second portion 366 defining a cavity 370. In the illustrated construction, a diameter of the first portion 362 is smaller than a diameter of the second portion 366. The nozzle 350 includes a nozzle inlet 374, a nozzle outlet 378, and a nozzle cavity 382 formed between the nozzle inlet 374 and the nozzle outlet 378. The nozzle inlet 374 is aligned with the feed fluid inlet 314 of the cartridge 310 and spaced from the cavity 360 formed in the bottom of the cartridge 310 so that the cavity 360 acts as a suction zone. In the illustrated construction, the nozzle cavity 382 includes a cylindrical portion 394 proximate the nozzle inlet 374 and a tapered portion 398 proximate the nozzle outlet 378. The tapered portion 398 is shaped so that a cross-sectional area of the tapered portion 398 decreases towards the nozzle outlet 378. Accordingly, a cross-sectional area of the nozzle inlet 374 is larger than a cross-sectional area of the nozzle outlet 378.

The venturi tube 354 is formed by a valve body 406 positioned in the cavity 370 of the second portion 366 of the fluidizer 326. The venturi tube 354 is seated against a wall 390 formed between the first portion 362 and the second portion 366 of the fluidizer 326. In the illustrated construction, the valve body 406 is a duckbill valve body. The valve body 406 forms a cavity 410 and includes a valve outlet 414. The cavity 410 is adjacent and in fluid communication with the nozzle outlet 378. The cavity 410 includes a first portion 422 having a generally circular cross section and a second portion 426 having a generally trapezoidal cross section. The valve outlet 414 is formed in an upper wall 432 of the second portion 426. In the illustrated construction, the valve outlet 414 is a rectangular slit. Accordingly, a cross-sectional area of the cavity 410 is wider than a cross-sectional area of the valve outlet.

In the construction of FIGS. 11-13, a venturi tube extension 434 (FIG. 12) is engaged with the venturi tube 354. The venturi tube extension 434 is substantially similar to the venturi tube extension 186 and will not be described in detail for the sake of brevity.

The fluidizer 326 therefore entrains media into the fluid flow and boosts the pressure of the fluid so that the fluid flows higher in the contact chamber 322 than it would under the conventional contact chamber configuration 10, 10′. A shown in FIG. 9, the fluidized media is discharged out of the venturi tube 354. A volume of the treated fluid (arrows 432) flows around the deflector cap 338 and through the treated fluid outlet 318. A volume of fluid and media (arrows 436) equal to the volume of fluid and media is drawn in through the suction opening(s) 358 is recirculated back to the bottom of the contact chamber and into the suction opening(s) 358 again. Thus, the fluidizer 326 increases the volumetric flow of fluid and media in the contact chamber 322 compared to a conventional single-pass contact chamber 10, 10′.

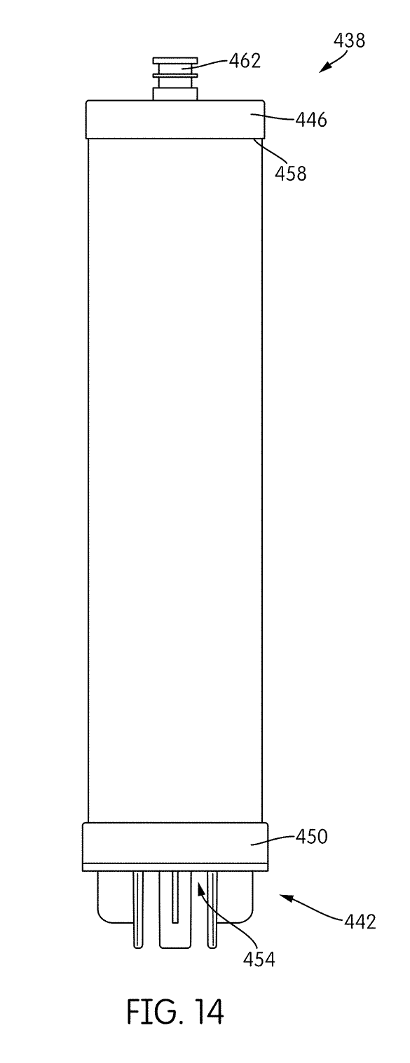

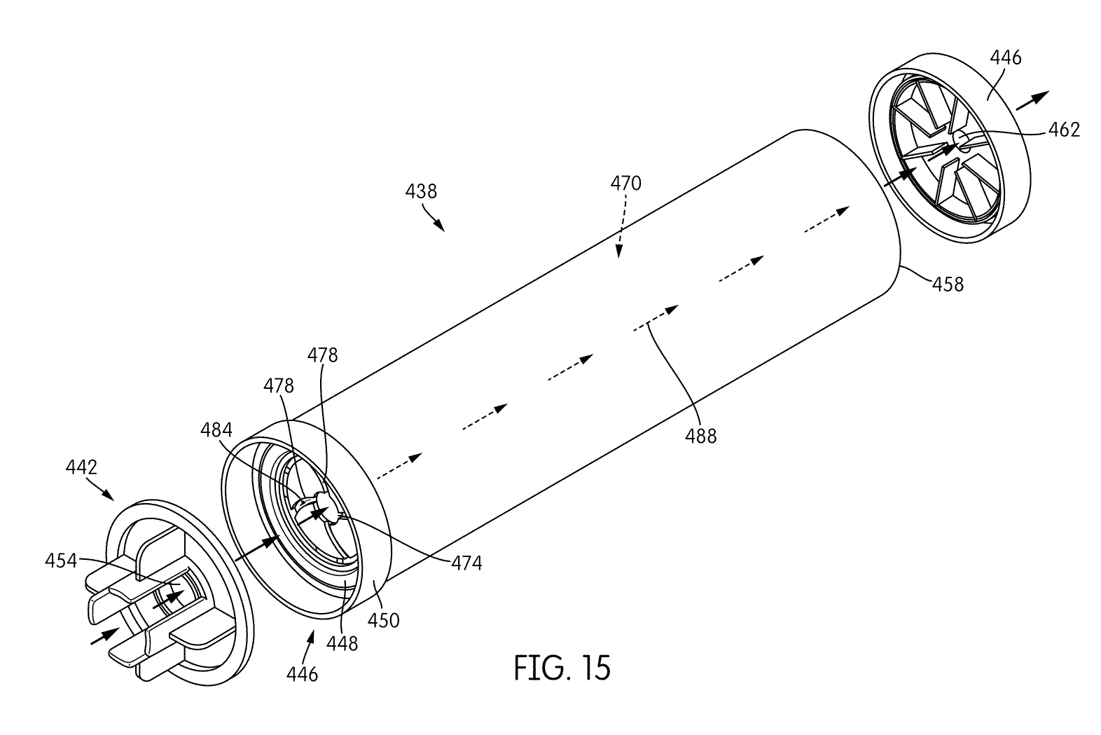

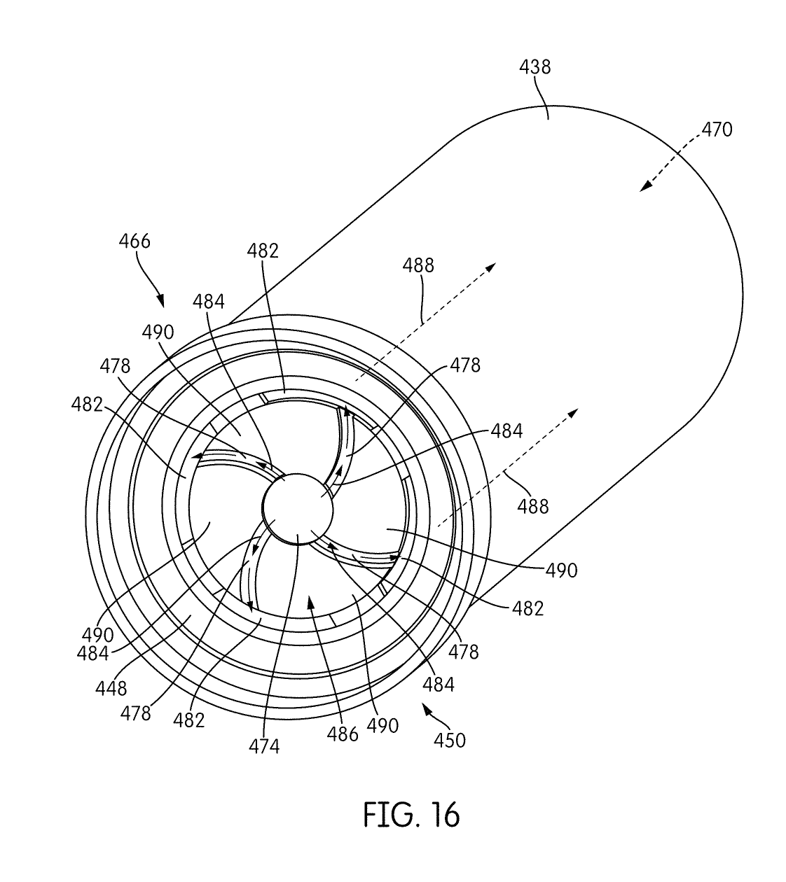

FIGS. 14-16 illustrate a cartridge 438 according to another construction. The cartridge 438 includes an inlet cap 442 and an outlet cap 446. The inlet cap 442 is engaged with a mounting wall 448 formed in an inlet end 450 of the cartridge 438 and includes a feed fluid inlet 454. The feed fluid inlet 454 may be adapted to engage a fluid inlet conduit (not shown) for receiving feed fluid from a source. The outlet cap 446 is engaged with an outlet end 458 of the cartridge 438 and includes a treated fluid outlet 462. The treated fluid outlet 462 may be adapted to engage a fluid outlet conduit (not shown) for transferring treated fluid to a downstream application. The cartridge 438 and the inlet cap 442 cooperatively form a fluidizer 466 (FIGS. 15-16). The cartridge and the outlet cap 446 cooperatively form a contact chamber 470. The contact chamber 470 may include a lower mesh layer, an upper mesh layer, a deflector cap, and media similar to what is described above with respect to FIGS. 5-7.

As shown in FIG. 16, the fluidizer 466 is formed in the inlet end 450 of the cartridge 438. The fluidizer 466 includes a fluidizer inlet 474, a plurality of radial flow paths 478, and a plurality of circumferential slits 482. The fluidizer inlet 474 and the plurality of radial flow paths 478 are formed in a wall 486 of the cartridge 438. The circumferential slits 482 are formed about a circumference of the wall 486. The wall 486 includes securing portions 490 engaged with the inlet cap 442 in a fluid-tight connection. Accordingly, all of the fluid entering the contact chamber 470 must pass along a flow path defined by the feed fluid inlet 454, the fluidizer inlet 474, the radial flow paths 478, and the circumferential slits 482 to enter the contact chamber 470. As shown by the arrows 484, the fluid travels along the radial flow paths 478, the fluid flows in a direction generally perpendicular to the flow path of fluid entering the fluidizer 466 at the fluidizer inlet 474. As shown by the arrows 488, when the fluid enters the circumferential slits 482 from the radial flow paths 478, the fluid flows in a direction generally perpendicular to the flow path of the fluid in the radial flow paths 478. The flow pattern produced by the radial flow paths 478 and the circumferential slits 482 causes the fluid to flow in a manner that fluidizes the media bed.

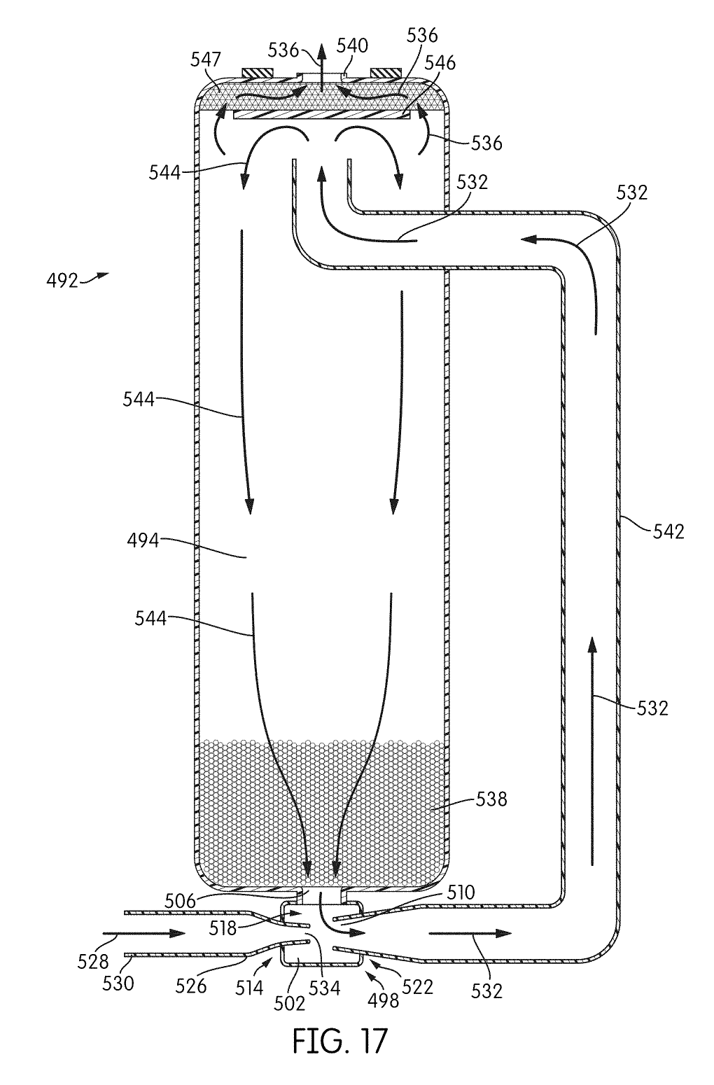

FIG. 17 illustrates a cartridge 492 including contact chamber 494 fitted with a fluidizer 498 that is an external eductor. The fluidizer 498 is positioned beneath the contact chamber 494. A suction conduit 502 is positioned between a bottom of the contact chamber 494 and the external fluidizer 498. An inlet 506 of the suction conduit 502 is positioned within an area of the contact chamber 494 that is occupied by the media bed in an at-rest condition. An outlet 510 of the suction conduit 502 is connected with the fluidizer 498. The external fluidizer 498 includes an eductor nozzle 514, a suction zone 518, and a venturi tube 522. The eductor nozzle 514 includes an inlet 526 engaged with a feed fluid conduit 530 and an outlet 534 positioned in the suction zone 518. The suction zone 518 is generated or established between the eductor nozzle 514 and the venturi tube 522. The venturi tube 522 is spaced from the eductor nozzle 514 within the suction zone 518.

With continued reference to FIG. 17, the fluid enters the fluidizer 498 (arrow 528) through the feed fluid conduit 530 and the nozzle 514, resulting in a high velocity of fluid through the suction zone 518 and into the venturi tube 522. This creates a vacuum in the suction zone 518 which draws a fluid and media mixture through inlet 506 into the suction zone 518. The media 538 is entrained into the fluid feed flow to form a mixture. The mixture travels through an external conduit 542 that extends along an exterior of the contact chamber 494 (arrows 532), and enters the contact chamber 494 proximate a deflector cap 546. A portion the fluid flows around the deflector cap 546 (arrows 536) and exits the contact chamber 494 through a treated fluid outlet 540. The deflector cap 546 deflects much of the portion of fluid and media downwardly along the sides of the contact chamber 494 (arrows 544), recirculating the mixture of media and fluid. The media 538 is fully fluidized within the contact chamber as a result of the mixing in the suction zone 518 and external conduit 542, and introducing the media and fluid at the top of the contact chamber 494 against the deflector cap 546. A mesh layer 547 is positioned between the deflector cap 546 and the treated fluid outlet 540 to prevent media from entering the treated fluid outlet 540.

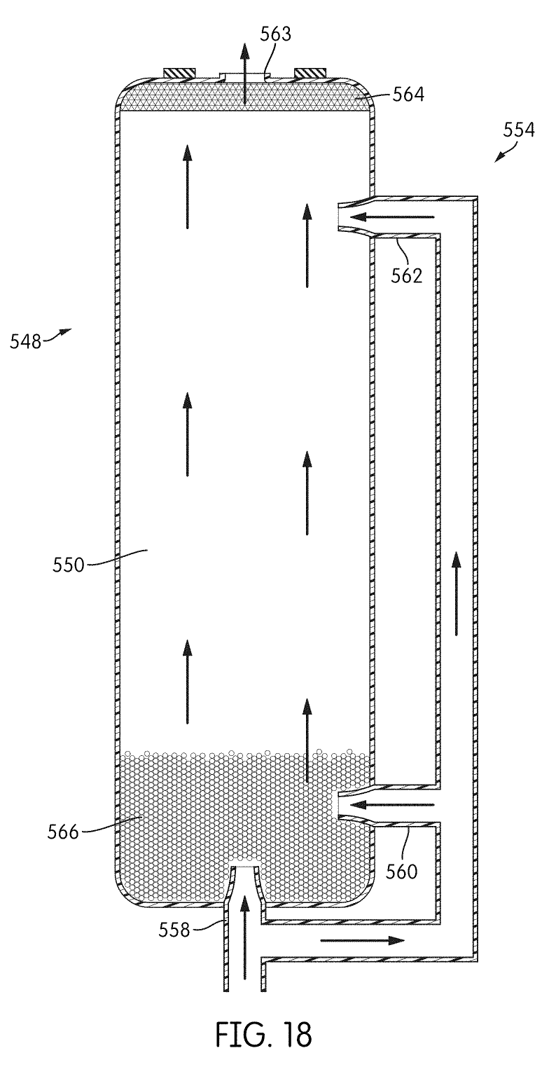

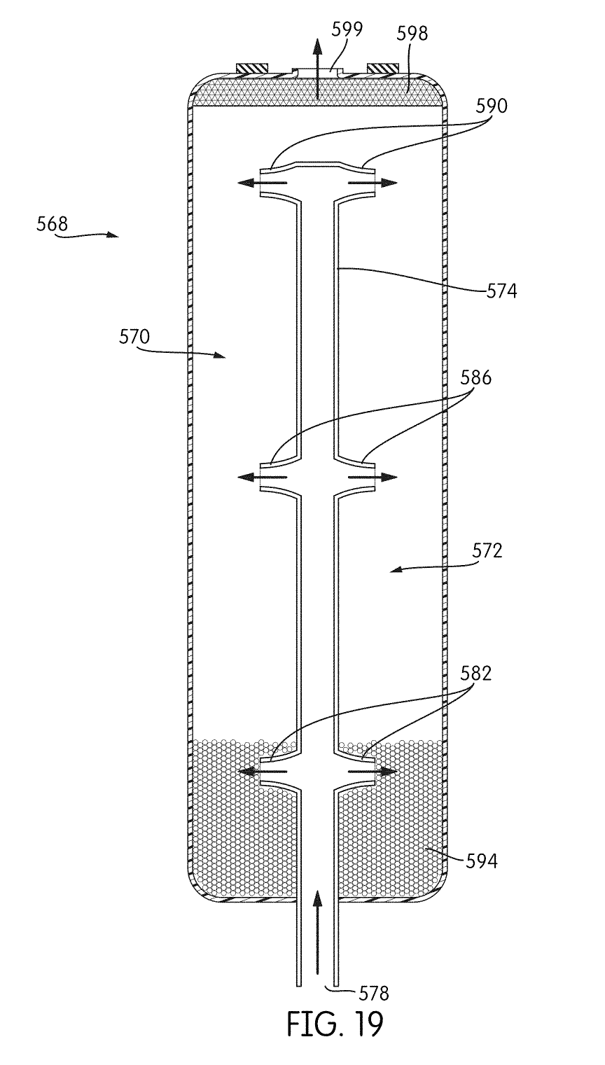

FIGS. 18 and 19 illustrate alternative constructions of a cartridge having a contact chamber having a fluidizer in which strategically-positioned and angled nozzles form the fluidizer. The strategic positioning and angling of the nozzles causes the media to become fully fluidized in the contact chamber. In these constructions, fluidization is achieved without an eductor. The nozzles are positioned and angled to promote recirculation in the contact chamber. Although single nozzles (FIG. 18) and pairs of nozzles (FIG. 19) are illustrated, it will be understood that nozzles can be provided in singles, pairs, or sets of more than two in alternative constructions to promote fluidization and recirculation. Also, although the angles of the nozzles are illustrated as vertical and horizontal, these nozzle angles can be adjusted to achieve the desired results, as noted below.

FIG. 18 illustrates a cartridge 548 having contact chamber 550 including a fluidizer 554 comprising a plurality of external mixing nozzles 558, 560, 562. A first mixing nozzle 558 is positioned at a bottom of the contact chamber 550 within an area occupied by the media bed in an at-rest condition. A second mixing nozzle 560 is positioned along a side of the contact chamber 550 and within the area occupied by the media bed in the at-rest condition. A third mixing nozzle 562 is positioned along a side of the contact chamber and above the second mixing nozzle 560. The third mixing nozzle 562 is disposed above the area occupied by the media bed in an at-rest condition. Feed fluid flowing into the contact chamber 550 through the first mixing nozzle 558 and the second mixing nozzle 560 lifts the media 566 and causes the media 566 to become at least partially fluidized. Feed fluid flowing into the contact chamber 550 through the second mixing nozzle 560 and the third mixing nozzle 562 urges fluid in a horizontal direction. The combination of vertical flow from the first mixing nozzle 558 and the horizontal flow of the second mixing nozzle 560 and the third mixing nozzle 562 cause mixing of the media 566 and the fluid. The result is a fully fluidized contact chamber 550 of media and fluid with vertical and horizontal components of flow. This promotes thorough mixing and recirculation of the media 566. Treated fluid flows out of the contact chamber 550 through a treated fluid outlet 563. A mesh layer 564 is positioned near the treated fluid outlet 563 to prevent the media 566 from entering the treated fluid outlet 563.

FIG. 19 illustrates a cartridge 568 having a contact chamber 570 including a fluidizer 572 comprising a plurality of internal mixing nozzles. A distribution tube 574 extends from a feed fluid inlet 578 at the bottom of the contact chamber 570 up through the at-rest media bed and to the top portion of the contact chamber 570. The distribution tube 574 includes a first pair of mixing nozzles 582, a second pair of mixing nozzles 586, and a third pair of mixing nozzles 590. The first pair of mixing nozzles 582 is illustrated as horizontal, but may be angled down toward the bottom of the contact chamber 570 within an area occupied by the media bed in an at-rest condition. The downward flow of feed fluid from the first pair of mixing nozzles 582 reaches the bottom of the contact chamber 570 and deflects upwardly, causing an upward flow of media 594 that has settled along the bottom of the contact chamber 570. The second pair of mixing nozzles 586 is positioned above the first pair of mixing nozzles 582. In the illustrated construction, the second pair of mixing nozzles 586 is above the at-rest height of the media bed. The second pair of mixing nozzles 586 directs feed fluid horizontally or radially toward the walls of the contact chamber 570. The feed fluid flowing radially from the second pair of mixing nozzles 586 deflects up and down off the side walls of the contact chamber 570, mixing the media and the fluid. The third pair of mixing nozzles 590 is directed upward to send feed fluid upwardly. A portion of the upward flow of feed fluid from the third pair of mixing nozzles 590 deflects off a top of the contact chamber 570 or off a screen 598 or deflector (not shown) near the top of the contact chamber 570. Another portion of the fluid flows out of the contact chamber 570 through the treated water outlet 599. The net result of the three pairs of nozzles 582, 586, 590 is to cause full fluidization and recirculation of the media 594 in the contact chamber 570. Although the nozzles 582, 586, 590 are illustrated in pairs in the two-dimensional drawing of FIG. 19, there may be more than two nozzles in each set. For example, there may be three or four nozzles, with some being directed into or out of the page to a selected degree.

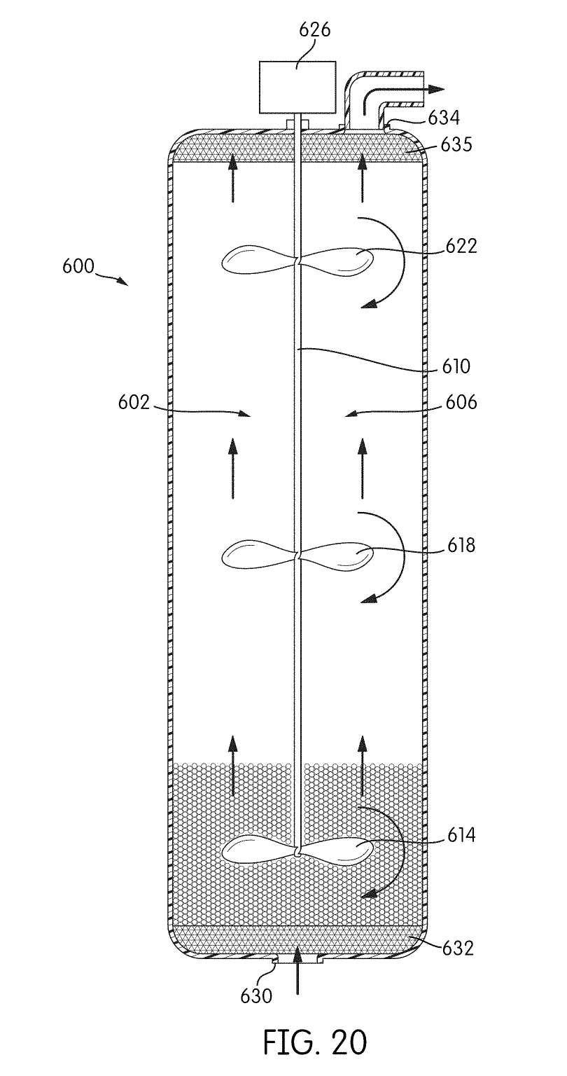

FIG. 20 illustrates a cartridge 600 having a contact chamber 602 including a fluidizer 606 that does not use an eductor or nozzles to promote fluidization and recirculation. Instead, an internal shaft 610 is provided in the contact chamber 602. The internal shaft 610 includes one or more mixer blades. A first mixing blade 614 is positioned proximate a bottom of the contact chamber 602 within an area occupied by the media bed in an at-rest condition. A second mixing blade 618 may be disposed above the first mixing blade 614. A third mixing blade 622 may be disposed above the second mixing blade 618. The internal shaft 610 is rotated by a motor 626 to cause mechanical mixing and recirculation of the mixture of fluid and media in the contact chamber 602. The motor 626 may be powered by electricity, water, air, or any other suitable motive force. Feed fluid enters through a feed fluid inlet 630 in a bottom of the contact chamber 602. A lower mesh layer 632 is positioned adjacent the feed fluid inlet 630 to prevent media from entering the feed fluid inlet 630. Treated fluid exits the contact chamber 602 through a treated fluid outlet 634 positioned at a top of the contact chamber 602. An upper mesh layer 635 is positioned adjacent the treated fluid outlet 634 to prevent the media from entering the treated fluid outlet 634.

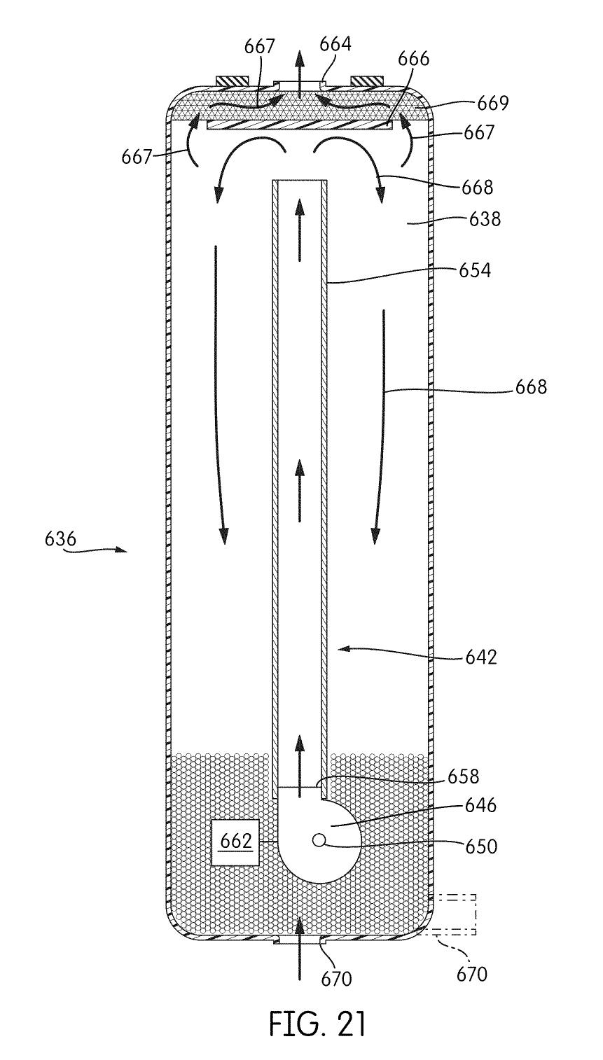

FIG. 21 illustrates a cartridge 636 having a contact chamber 638 including a fluidizer 642 that does not use an eductor or nozzles or mixer blades to promote fluidization and recirculation. Instead, a submersible pump 646 is positioned in the contact chamber 638. The submersible pump 646 has an inlet 650 within an area of the contact chamber 638 that is occupied by the media bed in an at-rest condition. A tube 654 is engaged with an outlet 658 of the submersible pump 646 and extends towards a top of the contact chamber 638. The submersible pump 646 includes a motor 662 that creates a vacuum at the inlet 650 of the submersible pump 646, which entrains a mixture of feed fluid and media from a bottom of the contact chamber 638 and releases the combined flow of fluid and media proximate a deflector cap 666 positioned near the top of the contact chamber 638. A portion of the treated fluid flows around the deflector cap 666 and exits the contact chamber 638 through a treated fluid outlet 664 (arrows 667). Much of the combined flow of fluid and media is deflected by the deflector cap 666 (arrows 668) to promote full fluidization and recirculation. A mesh layer 669 is positioned between the deflector cap 666 and the treated fluid outlet 664 to prevent media from entering the treated fluid outlet 664. A feed fluid inlet 670 may be positioned at the bottom of the contact chamber 638 or at a side of the contact chamber 638 and proximate to the bottom of the contact chamber 638. The motor 662 of the submersible pump 646 may be driven electrically, hydraulically, pneumatically, or by any other suitable motive force.

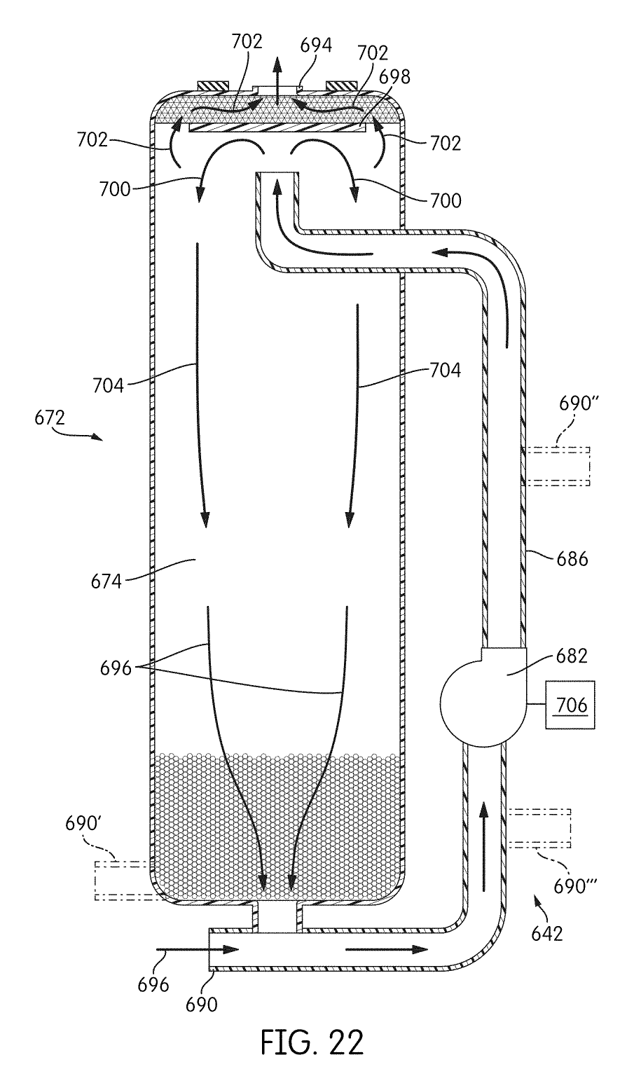

FIG. 22 illustrates a cartridge 672 including a contact chamber 674 that includes a fluidizer 642 comprising an external pump 682. In the illustrated construction, the external pump 682 is positioned along an external conduit 686 having a feed fluid inlet 690 at a bottom of the contact chamber 674 and an outlet proximate 694 a top of the contact chamber 674. As shown in FIG. 22, in some constructions the feed fluid inlet 690′ may be at a side of the contact chamber 674 proximate the bottom of the contact chamber 674. In an alternate construction, the feed fluid inlet 690″ may be positioned along the external conduit 686 and downstream of the external pump 682. In the alternate construction, the feed fluid inlet 690 may be positioned along the external conduit 686 and upstream of the external pump 682.

A suction force downstream of the external pump 682 pulls a mixture of feed fluid and a mixture of media and fluid from the bottom of the contact chamber 674 into the external conduit 686 (arrows 696). The external conduit 686 releases the mixture of media and feed fluid proximate a deflector cap 698 (arrows 700). A portion of the treated fluid flows around the deflector cap 698 (arrows 702) and flows through the treated fluid outlet 694. The deflector cap 698 deflects a portion (which may be a majority in some constructions) of the fluid and media mixture downward (arrows 704), creating recirculation of the media and fluid mixture as discussed above. A mesh layer 699 is positioned between the deflector cap 698 and the treated fluid outlet 694 to prevent the media from entering the treated fluid outlet 694. A motor 706 of the external pump 682 may be driven electrically, hydraulically, pneumatically, or by any other suitable motive force.

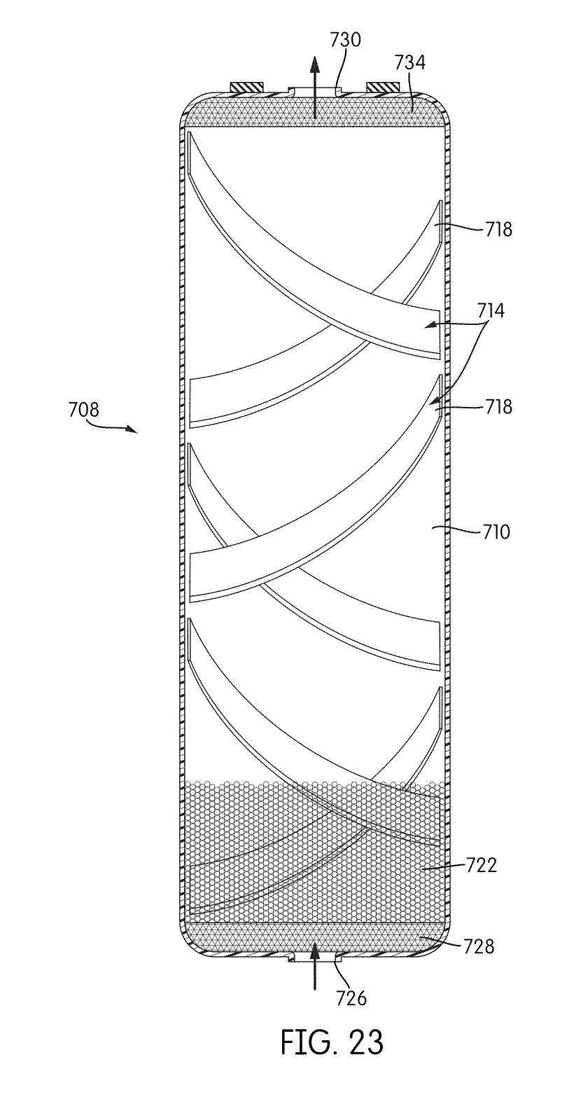

FIG. 23 illustrates a cartridge 708 having a contact chamber 710 that includes a fluidizer 714 comprising internal baffles 718 or mixing blades. The internal baffles 718 extend along a majority of an internal area of the contact chamber 710 and cause mixing of the fluid and media 722 by forcing the fluid and media 722 to follow a tortuous flow path between a feed fluid inlet 726 at a bottom of the contact chamber and a treated fluid outlet 730 at a top of the contact chamber 710. A lower mesh layer 728 is positioned adjacent the feed fluid inlet 726 to prevent media from entering the feed fluid inlet 726. An upper mesh layer 734 is positioned adjacent the treated fluid outlet 730 to prevent media from entering the treated fluid outlet 730.

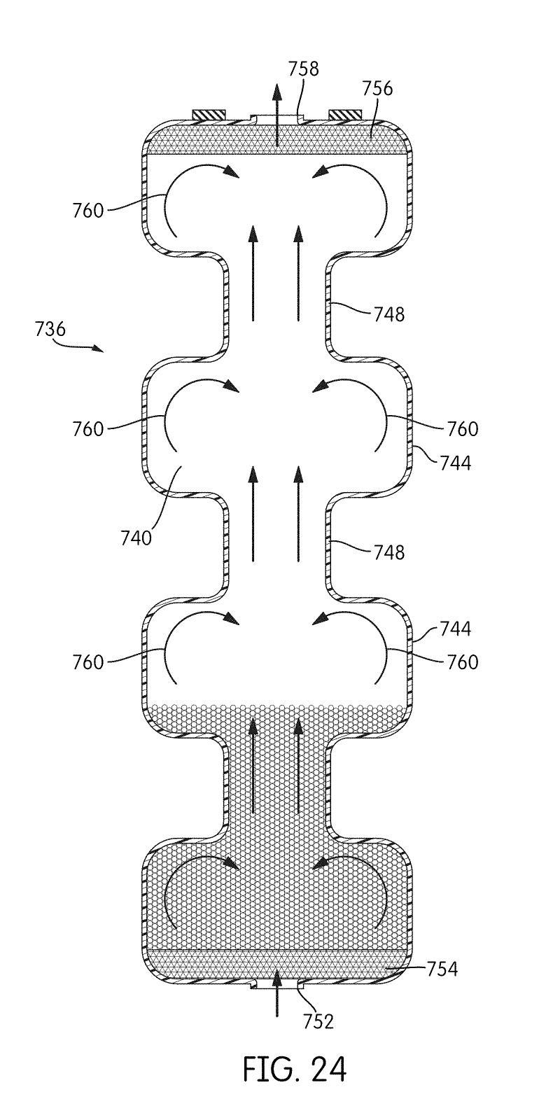

FIG. 24 illustrates a cartridge 736 including a contact chamber 740 having an irregular shape that acts as a fluidizer. As shown in FIG. 24, adjacent portions of the contact chamber 740 have different cross-sectional shapes. For example, a first portion 744 may have a cross section substantially larger than a second 748, adjacent, portion. The alternating first and second cross sections cause the flow velocity to change as the fluid travels between adjacent portions 744, 748. As shown by the arrows 760, when the flow encounters a portion having an increased cross-sectional area, a portion of the fluid will circulate within the wider first portions 744, mixing the media and the fluid. Although the contact chamber 740 of FIG. 24 is symmetrical about a central axis, the contact chamber 740 may be asymmetrical in other constructions. A lower mesh layer 754 is positioned adjacent a feed fluid inlet 752 to prevent media from entering the feed fluid inlet 752. An upper mesh layer 756 is positioned adjacent a treated fluid outlet 758 to prevent media from entering the treated fluid outlet 758.

Each of the various constructions described above includes a fluidizer to promote full fluidization and recirculation of the media in the contact chamber. The fluidizer can take any form that achieves these purposes. Examples given above for fluidizers include: eductors, nozzles, mixer blades, pumps, baffles, and irregular wall shapes, but these examples are not limiting of the disclosure. It is within the scope of the present disclosure to use combinations of these exemplary fluidizers and other forms of fluidizers to fully fluidize and recirculate the media in the contact chamber.

### Example Fluidization Study

A study was conducted of the range of flow velocities over which full fluidization can occur in a given contact chamber. The study first found the range of flow velocities for a conventional contact chamber, and then studied the range of flow velocities for a contact chamber according to the present disclosure.

The contact chambers in the study used an up-flow configuration (because the scale control media has a specific gravity greater than 1.0) so that feed water enters the contact chamber from a bottom of the contact chamber and exits at a top of the contact chamber. The test conditions for the fluidization study were:
Scale control media had a diameter of 0.2-1.2 mm, a density of 750 g/liter, and a void area of ˜40%, resulting in a specific gravity of ˜1.25.
The fluid was water at a temperature of 16° C.
The height of the test contact chamber was 30 cm and its inner diameter was 5 cm.
Three different media depths were tested (5 cm, 10 cm, and 15 cm).

Scale control media was added in the test contact chamber to yield 5, 10, and 15 cm media depth. Water was introduced into the test contact chamber at seven different flow rates and the resulting media height was measured at each flow rate.

The flow rate and fluidized media height for the conventional chamber (30 cm tall) are summarized in Table 1A (media height in cm) and Table 1B (percent media height expansion) below:

TABLE 1A

| Flow Velocity | | | |
|---|---|---|---|
| (cm/min) | Results (media height, cm) | | |
| 0 | 5 | 10 | 15 |
| 7 | 5 | 13 | 20 |
| 10 | 10 | 20 | 25 |
| 53 | 15 | 25 | Overflow |
| 80 | 20 | 30 | Overflow |
| 106 | 25 | Overflow | Overflow |
| 133 | 30 | Overflow | Overflow |
| 160 | Overflow | Overflow | Overflow |

TABLE 1B

| Flow Velocity | | | |
|---|---|---|---|
| (cm/min) | % of media expansion | | |
| 0 | 0% | 0% | 0% |
| 7 | 0% | 30% | 33% |
| 10 | 100% | 100% | 67% |
| 53 | 200% | 150% | Overflow |
| 80 | 300% | 200% | Overflow |
| 106 | 400% | Overflow | Overflow |
| 133 | 500% | Overflow | Overflow |
| 160 | Overflow | Overflow | Overflow |

In the Table 1A, full fluidization (30 cm) was witnessed only at 133 cm/min (i.e., at some flow range between 106 and 160 cm/min) for a 5 cm bed and only at 80 cm/min (i.e., at some flow range between 53 and 106 cm/min) for a 10 cm bed. The 15 cm bed did not become fully fluidized at any flow rate monitored and reached the overflow condition at a relatively low flow rate (53 cm/min) and above.

The test results show that in a conventional contact chamber the percent of bed expansion depends on the fluid velocity and characteristics of the media and fluid (for example specific gravity, viscosity, surface finish, etc.). The height of fluidization changes depending on the percent bed expansion and the depth of media. If the fluid velocity is too high, the frictional forces of the fluid acting on the media lift the media and cause some media to be trapped at the top of the contact chamber (overflow condition). In overflow conditions, most of the media may collect in the top of contact chamber generating a dead zone in the lower part of the contact chamber.

Even with the fluidized conditions, there are still inactive or dead zones in a conventional contact chamber. For 100% of the contact chamber to be active, the fluid velocity must be optimized. In a conventional contact chamber, this only occurs over a narrow flow range+/−less than about 27 cm/min. For example, referring to Table 1, full fluidization was only achieved in a 30 cm tall contact chamber for a 5 mm media bed between the flow rates of 106 and 160 cm/min (i.e., 133+/−27 cm/min) and for a 10 mm media bed between the flow rates of 53-106 (i.e., 80+/−˜27 cm/min). Full fluidization was not achievable in the test setup for a media bed of 15 cm in a conventional contact chamber. This also shows that the optimum velocity changes based on initial media depth. Fluid temperature is another factor that can change the optimum velocity for full fluidization.

The flow rate and fluidized media height for a contact chamber including a fluidizer according to the present disclosure are summarized in Table 2 below:

TABLE 2

| Flow Velocity | Results | |
|---|---|---|
| (cm/min) | (media height, cm) | % Bed Expansion |
| 0 | 10 | 0 |
| 7 | 25 | 150% |
| 10 | 30 | 200% |
| 53 | 30 | 200% |
| 80 | 30 | 200% |
| 106 | 30 | 200% |
| 133 | 30 | 200% |
| 160 | 30 | 200% |

Based on Table 2, it is clear that full fluidization in the 30 cm contact chamber (i.e., where “Results” equals “30”) was achieved over a wide range of flow rates for an initial media bed height of 10 cm. The range of fluid velocity over which full fluidization was achieved was at least 150 cm/min. The upper limit of flow velocity at which full fluidization can occur was not reached in the study.

### Example Efficacy Study

Another study was conducted to compare the performance of a reverse osmosis (RO) membrane receiving water from a conventional contact chamber and from a contact chamber according to the present disclosure. The performance of the RO membranes was measured based on two factors: RO membrane permeate flow (Flux Rate) and RO membrane salt rejection.

Both contact chambers were 5 cm in diameter and 30 cm in height. The enhanced contact chamber was equipped with an eductor and diffuser tube extension as described above with respect to FIG. 5. Both contact chambers had 300 ml (225 g) of media or a (no flow) media depth of 15 cm. The water velocity was 100 cm/min. The conventional contact chamber was observed to have nearly 100% fluidized condition.

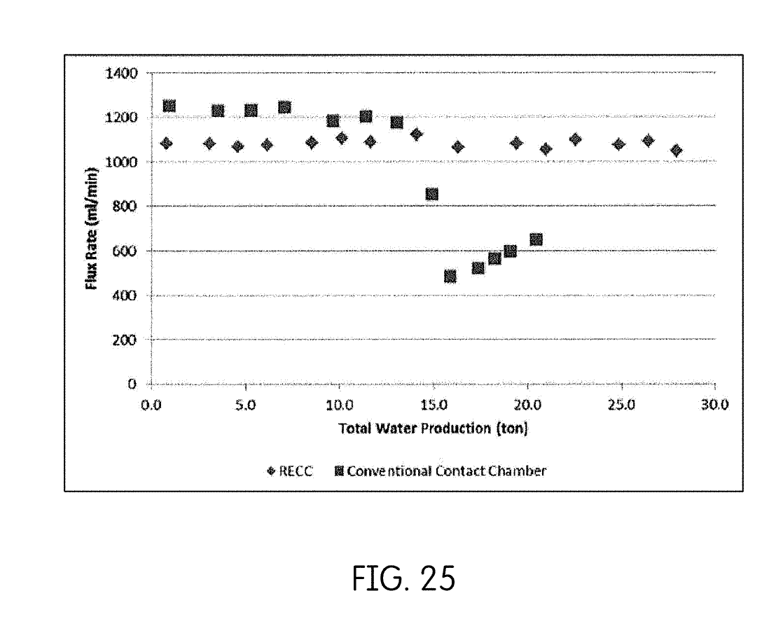

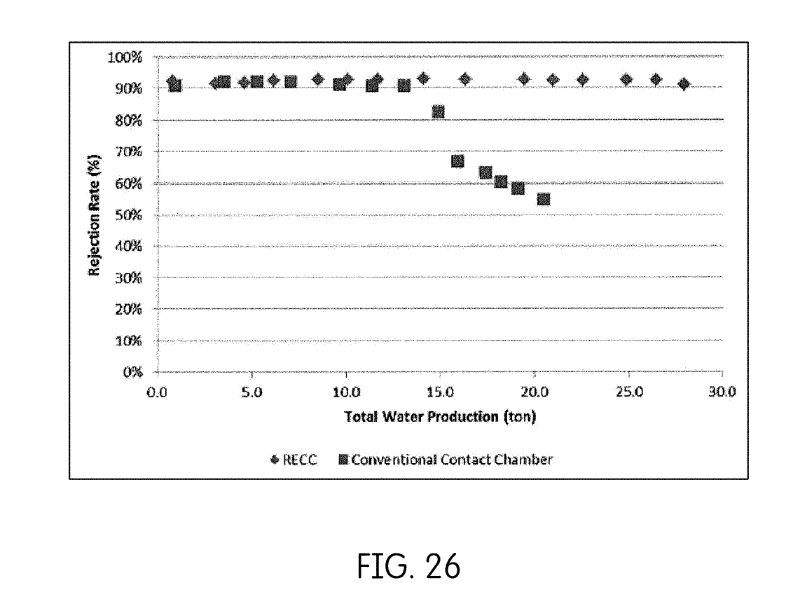

FIGS. 25 and 26 illustrate the results of the efficacy test for an RO system with a conventional contact chamber versus an RO system with a recirculating enhancing contact chamber (RECC). As can be seen in FIG. 25, the RO system that received water from a conventional contact chamber failed after producing ˜15 tons of purified water. The flux dropped by 50% with the dropping from ˜1200 to ˜500 ml/min. With reference to FIG. 26, the conventional RO system salt rejection dropped from ˜90% to ˜65% after producing 15 tons of purified water, and kept declining until the test was terminated at ˜20 tons.

The RO system receiving water from the RECC fared much better than the conventional setup. As illustrated in FIGS. 25 and 26, the RO system with RECC performed well through >28 tons of purified water (minimum life=22 tons). The test results show that the flux (FIG. 25) remained above 1000 ml/min and the salt rejection (FIG. 26) remained relatively constant at ˜90%.

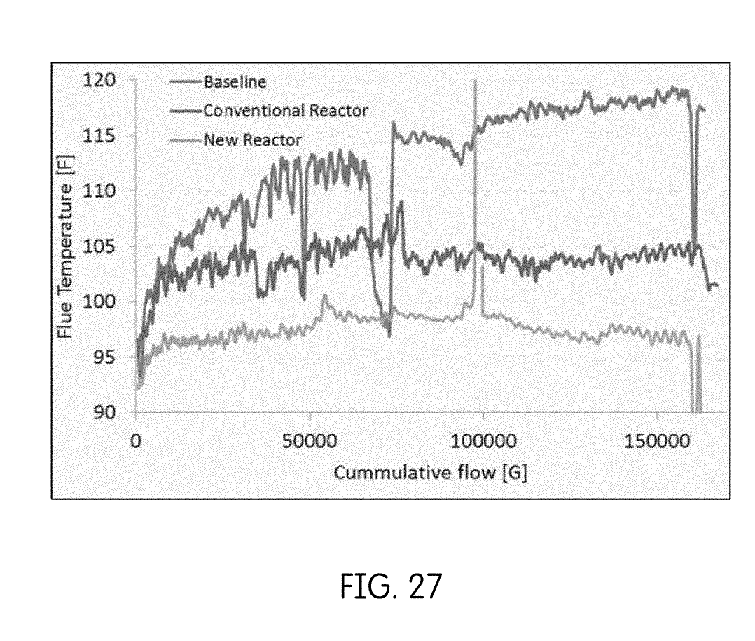

FIG. 27 is a graph showing the performance of the scale prevention system of the present disclosure when used before a tankless water heater. In this graph, the baseline condition is with no treatment, the “conventional reactor” is the same as a conventional reactor described above, and the “new reactor” is the improved RECC device of the present disclosure. The graph plots flue gas outlet temperature of the water heater as a function of the total gallons of water through the system. As scale builds up and insulates the heat exchange surfaces, less heat is transferred from the gas to the water, and the flue gas temperature increases. A level flue gas temperature is an indicator of a lack of scale formation. The flue temperatures for the new reactor are more consistent than those of the baseline or the conventional reactor, staying in the rage of 95-100 F for the tested water heater. By contrast, the baseline and conventional reactor plots show significant increases in flue gas temperature after a relatively low volume of water had flown through the heater.

Thus, the disclosure provides, among other things, a contact chamber in which the bed of fluid treatment media is fully fluidized by using a fluidizer. The fluidizer may be, for example, an internal or external eductor that acts as a pump for a media and fluid mixture to boost fluid flow and generate recirculation that keeps the media suspended in the fluid or an arrangement of nozzles, mixing blades, pumps, baffles, or irregular cross-sectional shapes (or combinations of any of these) to promote fully fluidizing the media in the chamber and causing the media to recirculate within the chamber. Various features and advantages of the disclosure are set forth in the following claims.

What is claimed is:

1. A fluid treatment device comprising:
a contact chamber;
a fluid inlet communicating with the contact chamber for the introduction of fluid into the contact chamber;
a fluid outlet communicating with the contact chamber for removal of fluid from the contact chamber such that a flow of fluid is established between the fluid inlet and the fluid outlet;
a bed of fluid treatment media for treatment of the fluid in the contact chamber; and
a fluidizer causing the fluid treatment media to be substantially fully fluidized within the fluid in the contact chamber;
wherein the fluidizer is at least one of an eductor, a nozzle, a mixing blade, a pump, a baffle or an irregular shape of the contact chamber.

2. The fluid treatment device of claim 1, wherein a substantial portion of the fluidizer is within the contact chamber.

3. The fluid treatment device of claim 1, wherein a substantial portion of the fluidizer is outside of the contact chamber.

4. The fluid treatment device of claim 1, wherein the fluidizer includes a nozzle for increasing the velocity of fluid within the contact chamber through the fluid inlet and a venturi for creating suction in response to receiving the flow of fluid from the nozzle, the suction entraining the fluid treatment media in the flow of fluid.

5. The fluid treatment device of claim 1, wherein the fluidizer includes an eductor that increases the velocity of fluid within the contact chamber and suction in response to the increased velocity to entrain the fluid treatment media in the flow of fluid.

6. The fluid treatment device of claim 1, wherein: the media bed is at a first end of the contact chamber; the fluidizer includes an extension tube extending through the media bed and operable to move media from the media bed to a second end of the interior chamber opposite the first end.

7. The fluid treatment device of claim 6, wherein the extension tube is length-adjustable or replaceable with an extension tube of different length to adjust the distance the fluidizer moves the media.

8. The fluid treatment device of claim 1, wherein the fluid inlet and fluid outlet communicate with opposite ends of the contact chamber.

9. A fluid treatment device comprising:
a contact chamber;
a fluid inlet communicating with the contact chamber for the introduction of fluid into the contact chamber;
a fluid outlet communicating with the contact chamber for removal of fluid from the contact chamber such that a flow of fluid is established between the fluid inlet and the fluid outlet;
a bed of fluid treatment media for treatment of the fluid in the contact chamber;
a fluidizer causing the fluid treatment media to be substantially fully fluidized within the fluid in the contact chamber; and
a recirculator that causes fluid to flow within the contact chamber in a direction away from the fluid outlet to facilitate fluidization of the fluid treatment media.

10. The fluid treatment device of claim 9, wherein the media bed is within the contact chamber.

11. The fluid treatment device of claim 9, wherein a substantial portion of the fluidizer is within the contact chamber.

12. The fluid treatment device of claim 9, wherein a substantial portion of the fluidizer is outside of the contact chamber.

13. The fluid treatment device of claim 9, wherein the fluidizer includes a nozzle for increasing the velocity of fluid within the contact chamber through the fluid inlet and a venturi for creating suction in response to receiving the flow of fluid from the nozzle, the suction entraining the fluid treatment media in the flow of fluid.

14. The fluid treatment device of claim 9, wherein the fluidizer includes an eductor that generates an increased velocity of fluid within the contact chamber and suction in response to the increased velocity to entrain the fluid treatment media in the flow of fluid.

15. The fluid treatment device of claim 9, wherein: the media bed is at a first end of the contact chamber; the fluidizer includes an extension tube extending through the media bed and operable to move media from the media bed to a second end of the interior chamber opposite the first end.

16. The fluid treatment device of claim 15, wherein the extension tube is length-adjustable or replaceable with an extension tube of different length to adjust the distance the fluidizer moves the media.

17. The fluid treatment device of claim 9, wherein the fluid inlet and fluid outlet communicate with opposite ends of the contact chamber.

18. A method of treating fluid in a contact chamber that includes a fluid inlet and a fluid outlet, the method comprising the steps of:
providing a bed of media within the contact chamber;
imparting movement of the media in a first direction toward the fluid outlet within the media contact chamber for the flow of treated fluid out of the contact chamber; and
imparting movement of the media in a second direction to recirculate the media within the contact chamber.

19. The method of claim 17, wherein imparting movement in a first direction includes moving the media from the fluid inlet toward the fluid outlet.

20. The method of claim 18, further comprising creating the flow of fluid with one of an eductor, a nozzle, a mixing blade, a pump, a baffle or an irregular shape of the contact chamber.

21. The method of claim 17, further comprising positioning the media bed within the contact chamber.

22. The method of claim 17, further comprising positioning a substantial portion of a fluidizer within the contact chamber and imparting movement of the media in at least one of the first direction or the second direction under the influence of the fluidizer.

23. The method of claim 17, further comprising positioning a substantial portion of a fluidizer outside of the contact chamber and imparting movement of the media in at least one of the first direction or the second direction under the influence of the fluidizer.

24. The method of claim 17, wherein imparting movement of the media in the second direction is accomplished with a deflector that at least partially blocks movement of the media in the first direction.

25. The method of claim 17, wherein imparting movement of the media in the second direction is accomplished with a flow of fluid in the second direction within the contact chamber.
